(19) United States
(12) Patent Application Publication
(10) Pub. No.: US 2025/0270350 A1
(43) Pub. Date: Aug. 28, 2025

(54) ULTRASOUND-ASSISTED FRONTAL METATHESIS REACTION, PRODUCTS THEREOF, AND DEVICE FOR USE THEREWITH

(71) Applicant: The Hong Kong University of Science and Technology, Hong Kong (CN)

(72) Inventors: Jinglei YANG, Hong Kong (CN); Sepideh Sadat HOSSEINI NOORABADI, Hong Kong (CN)

(21) Appl. No.: 19/008,736

(22) Filed: Jan. 3, 2025

Related U.S. Application Data
(60) Provisional application No. 63/617,425, filed on Jan. 4, 2024.

(51) Int. Cl. C08F 4/80; C08F 2/56; C08K 7/06

(52) U.S. Cl. CPC C08F 4/80; C08F 2/56; C08K 7/06

(57) ABSTRACT

A method for performing a metathesis reaction, the method including: providing a reaction solution comprising at least one olefin substrate and a metathesis catalyst; and exposing the reaction solution to ultrasound thereby inducing the metathesis reaction; products thereof; and a device for performing the metathesis reaction.

### CROSS-REFERENCE TO RELATED APPLICATIONS

The present application claims priority from U.S. Provisional Patent Application No. 63/617,425, filed on Jan. 4, 2024, which is hereby incorporated by reference in its entirety.

### TECHNICAL FIELD

The present disclosure generally relates to the field of metathesis chemistry, and more particularly to a method for scalable and energy-efficient ring-opening metathesis polymerization of high-performance polymers and composites.

### BACKGROUND

The increasing demand for high-performance polymers and composites across various applications has driven researchers to investigate innovative curing methods that are energy-efficient and highly effective compared to traditional autoclave or oven curing methods, which require long curing times and expensive equipment. An ideal curing method should also be eco-friendly and cost-effective. Frontal ring-opening metathesis polymerization (FROMP) is one such technique, characterized by a self-sustaining chemical reaction initiated by an external trigger such as heat, resulting in the creation of a self-sustained reaction area called the “polymerization front”. Development of FROMP has the potential to revolutionize curing techniques of thermoset polymers, such as dicyclopentadiene (DCPD), because it is considered a zero-energy curing method, and it is very fast, meaning the production rate can increase several orders of magnitude. However, it has some limitations, such as lower mechanical properties compared to oven-cured polymers and composites, and the problem of scalability as the front may quench after passing a specific distance due to heat loss, hindering its use for industrial applications.

The main problem that hinders integration of FROMP into existing technologies is scalability. As the polymerization front may quench after passing a specific distance due to heat loss, this limits the size of the polymer that can be cured using FROMP, making it unsuitable for large-scale production. Moreover, lower mechanical properties such as tensile strength and toughness compared to oven-cured polymers are due to the rapid heating and cooling that occurs during FROMP, which can result in incomplete cross-linking, polymer degradation, and the formation of defects. On the other hand, the exothermic nature of FROMP can pose safety concerns, as the high temperatures generated during the reaction can cause the risk of thermal runaway or ignition of flammable materials in the vicinity. Decreasing the front temperature while maintaining the same front velocity may contribute to safety concerns.

Up to now, some strategies have been explored to address the above-mentioned challenges. One potential solution to the challenges of frontal polymerization involves the use of embedded conductive fibers, such as copper or stainless-steel wires and carbon fibers, to aid in the heat transfer through the reaction media. These fibers can act as thermal conduits, enhancing the heat transfer and reducing the reaction time. The use of embedded conductive fibers can also increase the safety of frontal polymerization by reducing the risk of thermal runaway and explosion. However, this method will change the front shape, and this cannot be used to fabricate pure polymer products. Another strategy to address the challenges of frontal polymerization is multipoint ignition, whereby multiple sites undergo simultaneous initiation and propagation. Multipoint ignition can improve the scalability of frontal polymerization by reducing the reaction time and enabling the synthesis of larger quantities of polymers. But the interfaces between the multiple propagation sites, however, may introduce structural defects. When two high-temperature fronts merge, the temperature spike in the boundary will cause polymer degradation, acting as a defect leading to failure in service.

There is thus a need for improved methods of FROMP that address or overcome at least some of the shortcomings in the art thereby producing polymers and composites with desirable properties, including one or more of: low energy consumption, high tensile strength, high tensile ductility, high toughness, and production efficiency compared to oven-cured polymers.

### SUMMARY

FROMP is conventionally initiated by heat or light, while we introduce the use of ultrasound mechanical waves to start FROMP. We mention that the nature of the input energy may directly influence the FROMP procedure and the following polymer structure. When we use heat, it only affects the excitation point while the mechanical waves during initiation will influence the whole reaction solution including Grubb's catalysts and monomers. The main difference between heat and ultrasound waves as forms of energy lies in their mechanisms of transfer and their effects on materials. The mechanism of energy transfer is different for thermal and ultrasonic FROMP. Heat energy would be transferred to the medium through conduction. The heat source would raise the temperature of the molecules in direct contact with it. These heated molecules would then transfer their energy to neighbouring molecules, causing a gradual increase in temperature throughout the front movement and exothermic heat of reaction.

In contrast, ultrasound waves are mechanical waves that propagate through a medium by causing particles to oscillate. When ultrasound waves are applied to a side of the mold, they would create regions of compression and rarefaction in the reaction solution. These oscillations would induce mechanical vibrations in the molecules, leading to localized heating and the generation of acoustic streaming and microstreaming effects. As ultrasound waves with frequencies between 20 kHz and 1 MHz have demonstrated potential in various synthetic chemistry applications, including polymer degradation and synthesis. Taking advantage of ultrasonic cavitation, sonochemical initiation provides an energy-efficient and sustainable approach to polymer curing. Sonochemistry has been reported to exhibit numerous effects on chemical reactions, such as enhancing reaction rates, reducing reaction times, and improving yields by favouring specific reaction pathways unattainable through conventional heating methods. These findings can be attributed to simultaneous reactions. Thus, in the methods described herein, polymers are produced by harnessing the effectiveness of ultrasound waves to initiate a front, taking positive advantages of ultrasound waves compared to focused thermal heating. Thus, the ultrasound waves and acoustic cavitation provide hot spots that can initiate the FROMP, which propagates with low temperature while yielding a fully cured polymer with tensile properties that outperform the thermal FROMP and oven-cured samples. Ultrasonic FROMP lets us tune mechanical properties by altering the ultrasound parameters such as amplitude. Decrease of front temperature can also contribute to safety concerns as the FROMP is less exothermic while still yielding a high-performance polymer.

In a first aspect, provided herein is a method for performing a metathesis reaction, the method comprising: providing a reaction solution comprising at least one olefin substrate and a metathesis catalyst; and exposing the reaction solution to ultrasound thereby inducing the metathesis reaction, with the proviso that the metatesis catalyst is not a tungsten, molybdenum, tantalum, ruthenium or rhenium oxyhalide, halide, oxide, or organic ammonium salt, a vinylidine, allenylidene or higher cumulenylidene complex comprising ruthenium or osmium, (p-cymene)RuCl(PCy₃)(═C═C═CPh₂)⁺, WCl₆/Me₄Sn, or

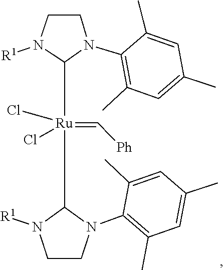

wherein R¹ is methoxy poly(butylene oxide)butyl.

In certain embodiments, the metathesis catalyst is a ruthenium metathesis catalyst, a molybdenum metathesis catalyst, an osmium metathesis catalyst, or a tungsten metathesis catalyst.

In certain embodiments, the metathesis catalyst has Formula 1:

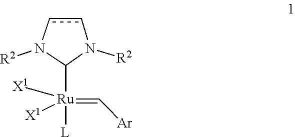

wherein L is PR³₃;
X¹ for each instance is independently an anionic ligand;
Ar is an optionally substituted phenyl;
R² for each instance is independently alkyl, cycloalkyl, or aryl; and
R³ for each instance is independently alkyl, cycloalkyl, or aryl.

In certain embodiments, the metathesis catalyst has a CAS Number selected from the group consisting of: CAS Number 172222-30-9, CAS Number 250220-36-1, Number 340810-50-6, CAS Number 1307233-23-3, CAS Number 536724-67-1, CAS Number 254972-49-1, CAS Number 246047-72-3, CAS Number 927429-60-5, CAS Number 373640-75-6, CAS Number 253688-91-4, CAS Number 1190427-50-9, CAS Number 1190427-49-6, CAS Number 1255536-61-8, CAS Number 1031262-76-6, CAS Number 934538-12-2, CAS Number 203714-71-0, CAS Number 1025728-56-6, CAS Number 1212008-99-5, CAS Number 301224-40-8, CAS Number 927429-61-6, CAS Number 635679-24-2, CAS Number 1025728-57-7, CAS Number 1212009-05-6, CAS Number 1383684-54-5, CAS Number 1632041-02-1, and CAS Number 1352916-84-7.

In certain embodiments, the metathesis catalyst has CAS Number 246047-72-3.

In certain embodiments, the at least one olefin substrate comprises a cyclic olefin.

In certain embodiments, the at least one olefin substrate comprises a cyclic olefin selected from the group consisting of norbornene, dicyclopentadiene, tricyclopentadiene, cyclooctene, cyclooctadiene, cyclobutene, cyclopropene, and an oxanorbornene.

In certain embodiments, the metathesis reaction is conducted at −20° C. to −10° C.

In certain embodiments, the ultrasound has a frequency of 20-100 kHz.

In certain embodiments, the reaction solution further comprises P(OR⁵)₃, wherein R⁵ for each instance is independently C₁-C₁₂ alkyl.

In certain embodiments, the reaction solution further comprises nanoparticles selected from the group consisting of metal oxides nanoparticles and carbon-based nanoparticles.

In a second aspect, provided herein is a method for performing a ring-opening metathesis polymeriztion reaction, the method comprising: providing a reaction solution comprising at least one olefin substrate, tributylphosphite, and a metathesis catalyst; and exposing the reaction solution to ultrasound thereby inducing the ring-opening metathesis polymeriztion reaction, wherein the metathesis catalyst has CAS Number 246047-72-3, the at least one olefin substrate comprises comprises a cyclic olefin selected from the group consisting of norbornene, dicyclopentadiene, tricyclopentadiene, cyclooctene, cyclooctadiene, cyclobutene, cyclopropene, and an oxanorbornene, and optionally methyl methacrylate, N-methylolacrylamide, or methacrylate, and the ultrasound has a frequency of 20-100 kHz.

In certain embodiments, the at least one olefin substrate comprises dicyclopentadiene.

In a third aspect, provided herein is a polymer prepared according to the method described herein.

In certain embodiments, the polymer further comprises metal oxide nanoparticles or carbon-based nanoparticles.

In certain embodiments, the polymer comprises polydicyclopentadiene, poly(dicyclopentadiene-co-methacrylate), or poly(dicyclopentadiene-co-methyl methacrylate).

In certain embodiments, the polymer further comprises carbon nanotubes.

In a fourth aspect, provided herein is a device for performing the metathesis reaction descrobed herein, the device comprising: a mold body for receiving the reaction solution; a first ultrasound probe; and a slide disposed on the mold body to form a reaction surface for the reaction solution to conduct the metathesis reaction, wherein the mold body defines a first opening for receiving the first ultrasound probe.

In certain embodiments, the device further comprises a second ultrasound probe and the mold body defines a second opening for receiving the second ultrasound probe, wherein the first ultrasound probe and the second ultrasound probe aer disposed at opposite ends of the mold body.

In certain embodiments, the mold body comprises polytetrafluoroethylene.

In certain embodiments, the device further comprises one or more thermocouples for measuring the the temperature of the reaction solution.

Provided herein is a method and system that enables rapid energy-efficient polymerization in cryogenic temperatures suitable for harsh environments where an in situ curing strategy is required to obtain high-performance polymers. In combination with the freezing effect of the reaction solution and ultrasound waves, we could obtain uniform polymers fabricated via multi-ignition, which is a forward approach to address the scalability issue of FROMP. Overall, the potential to produce thermoset polymers in large quantities could overcome long-standing yet urgent production challenges.

In another aspect, provided herein is a high-throughput system for producing polydicyclopentadiene (pDCPD) polymers with tuneable tensile strength, ductility, and toughness by optimizing the ultrasound parameters. The mechanical properties, thermomechanical properties, and thermal properties were systematically investigated and the effectiveness of the method described herein to produce pDCPD polymers via three-dimensional spherical fronts was demonstrated. Moreover, conducting the FROMP in −20° C. temperatures to obtain a tough and ductile polymer also revealed the versatility of this method and that can also address scalability and safety concerns.

### BRIEF DESCRIPTION OF THE DRAWINGS

The foregoing aspects and many of the attendant advantages of this invention will become more readily appreciated and understood by reference to the following detailed description, when taken in conjunction with the accompanying drawings.

FIG. 1 depicts a) an illustration of an exemplary ultrasonic FROMP system; and b) ultrasonic front propagation for a rectangular slab measuring 10 cm by 10 cm.

FIG. 2 depicts a bar chart showing changes in tensile strength and ductility by modifying the ultrasound acoustic power.

FIG. 3 depicts a a bar chart showing a comparison of energy consumption, curing time, and CO₂ emissions between ultrasonic FROMP, thermal FROMP, and traditional oven-cured samples.

FIG. 4 depicts a bar chart showing enhanced tensile strength and toughness values of ultrasonic FROMP compared to thermal FROMP and traditional oven-cured samples.

FIG. 5 depicts photopgraphs showing real-time monitoring of the polymerization front during the curing process for the cryo-FROMP method using a 2D-infrared thermal camera.

FIG. 6 depicts a a bar chart showing improved toughness, ductility, and tensile strength of cryo-FROMP samples compared to traditional oven-cured samples.

FIG. 7 depicts photographs showing two fronts approaching each other for 2-point initiation using ultrasonic cryo-FROMP, captured by a 2D-infrared camera.

FIG. 8 depicts a photograph showing carbon nanotube polydicyclopentadiene (CNT-pDCPD) composites produced using the ultrasonic-FROMP method.

FIG. 9 depicts a schematic representation of an exemplary setup for remote ultrasonic FROMP, including ultrasonic probe, reaction solution, water, and cavitation bubbles.

FIG. 10 depicts photographs showing three-dimensional front propagation in the reaction solution for remote ultrasonic FROMP.

FIG. 11 depicts a graph showing temperature profile during remote ultrasonic FROMP.

FIG. 12 depicts (a) an exemplary device (100) for performing the metathesis reaction described herein including a mold body (101) for receiving the reaction solution (107), a first ultrasound probe (102) and a slide (103) disposed on the mold body (101), wherein the mold body defines a first opening (106) for receiving the first ultrasound probe (102). (b) Acoustic wave together with schematic representations of bubble implosion due to negative pressure induced by ultrasound irradiation through the liquid reaction solution. (c) U-FROMP front propagation for a rectangular slab with 100 mm by 100 mm dimensions.

FIG. 13 depicts a profile view of an exemplary device for performing a FROMP of CFRP composites using a novel VARI design strategy.

FIG. 14 depicts dynamic DSC for DCPD reaction solution after seconds of sonication with various ultrasound intensities. Due to the high ring strain stored in the norbornene part of DCPD, the polymerization is highly exothermic.

FIG. 15 depicts U-FROMP energy consumption efficiency together with NMR studies and scalability potentials (a) Comparison of energy consumption and the time of cure for various acoustic powers, Th-FROMP, and conventional oven curing. (b) For mixture of G2 catalyst and tributyl phosphite (TBP) inhibitor after short seconds of ultrasoundation with ptimized power, free PCy₃ species and new ruthenium species could be observed in 31P NMR. (c) U-FROMP scale up via 2 points initiation showing a 70-100 cm by 5-10 cm sample fabricated by consuming 1-10 J cm⁻³ energy and time to cure of 0.02-0.04 min cm⁻³. This near zero-energy consumption together with reliable mechanical properties demonstrates the scalability potential of the U-FROMP method.

FIG. 16 depicts characterization of p-COD with the focus on: (a) 1H NMR spectrum of p-COD measured in CDCl₃ at 400 MHz. Key peaks include δ 5.3 corresponding to A_{cis} and δ 5.5 attributed to Aₜᵣₐₙₛ. (b) First heating cycle of DSC runs for p-COD, revealing an endothermic peak related to crystalline domains for US—extended ultrasonication sample. (c) GPC analysis of p-COD conducted in dimethylformamide (DMF) as the eluent. The chromatogram illustrates the molecular weight distribution of p-COD, with key parameters including the number-average molecular weight (Mₙ), weight-average molecular weight (M_{w}), and polydispersity index (PDI=M_{w}/Mₙ) indicated. Calibration was performed using polystyrene standards to relate elution volume to molecular weight.

FIG. 17 depicts tensile properties together with time to cure comparisons for p-DCPD polyolefins cured via remote U-FROMP using water or air medium showing comparable mechanical performance with oven cured samples while saving time for remote water (RW) and for remote air (RA) meaning a tremendous increase in production efficiency.

FIG. 18 depicts energy efficiency together with mechanical properties of CFRPs fabricated via U-FROMP method. (a) IR camera capture during reaction wave propagation. (b) real photo of frontal propagation. (c) Energy consumption and time to cure comparisons between direct U-FROMP and conventional curing methods showing tremendous savings in energy consumption and production time. (d) Tensile properties, and (e) Flexural properties compared to conventional oven curing representing improved mechanical properties compared to oven curing, meaning that we can save energy, time and obtain CFRPs with better mechanical performance.

FIG. 19 depicts (a) and (b) photos of copolymers with varying amounts of methacrylate fabricated via remote U-FROMP and Thermal FROMP showing even structure for copolymers developed by U-FROMP while the Thermal ones show tremendous fingering and for high proportion of MMA, the huge phase separation happened. (c) and (d) SEM micrographs of Polyolefins-Polymethacrylates showing obvious structural differences and more even structure for U-FROMP ones.

FIG. 20 depicts (a) IR captures reaction wave propagation under cryogenic temperatures via ultrasonic initiation. (b) 2 points initiation of Cryo-FROMP and (c) IR camera capture. (d) improvement of ductility for 2 points initiation using cryo-FROMP that paves the way for better scalability as the junction of meeting fronts does not act as an inferior part due to temperature spikes.

FIG. 21 depicts the rate of cure of direct U-FROMP, remote U-FROMP, and oven cured CFRPs.

### DETAILED DESCRIPTION

### Definitions

The following terms shall be used to describe the present invention. In the absence of a specific definition set forth herein, the terms used to describe the present invention shall be given their common meaning as understood by those of ordinary skill in the art.

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

The following terms shall be used to describe the present invention. In the absence of a specific definition set forth herein, the terms used to describe the present invention shall be given their common meaning as understood by those of ordinary skill in the art.

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

It should be understood that the order of steps or order for performing certain actions is immaterial so long as the present teachings remain operable. Moreover, two or more steps or actions may be conducted simultaneously.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

As used herein, “alkyl” refers to a straight-chain or branched saturated hydrocarbon group. Examples of alkyl groups include methyl-, ethyl-, propyl (e.g., n-propyl and isopropyl), butyl (e.g., n-butyl, iso-butyl, sec-butyl, tert-butyl), pentyl groups (e.g., 1-methylbutyl, 2-methylbutyl, iso-pentyl, tert-pentyl, 1,2-dimethylpropyl, neopentyl, and 1-ethylpropyl), hexyl groups, and the like. In various embodiments, an alkyl group can have 1 to 40 carbon atoms (i.e., C₁-C₄₀ alkyl group), for example, 1-30 carbon atoms (i.e., C₁-C₃₀ alkyl group). In certain embodiments, an alkyl group can have 1 to 6 carbon atoms, and can be referred to as a “lower alkyl group.” Examples of lower alkyl groups include methyl, ethyl, propyl (e.g., n-propyl and isopropyl), and butyl groups (e.g., n-butyl, isobutyl, sec-butyl, tert-butyl). In certain embodiments, alkyl groups can be optionally substituted as described herein. An alkyl group is generally not substituted with another alkyl group, an alkenyl group, or an alkynyl group.

As used herein, “cycloalkyl” by itself or as part of another substituent means, unless otherwise stated, a monocyclic hydrocarbon having between 3-12 carbon atoms in the ring system and includes hydrogen, straight chain, branched chain, and/or cyclic substituents. Exemplary cycloalkyls include cyclopropyl, cyclobutyl, cyclopentyl, cyclohexyl, cycloheptyl, and the like.

As used herein, “aryl” refers to an aromatic monocyclic hydrocarbon ring system or a polycyclic ring system in which two or more aromatic hydrocarbon rings are fused (i.e., having a bond in common with) together or at least one aromatic monocyclic hydrocarbon ring is fused to one or more cycloalkyl and/or cycloheteroalkyl rings. An aryl group can have 6 to 24 carbon atoms in its ring system (e.g., C₆-C₂₄ aryl group), which can include multiple fused rings. In certain embodiments, a polycyclic aryl group can have 8 to 24 carbon atoms. Any suitable ring position of the aryl group can be covalently linked to the defined chemical structure. Examples of aryl groups having only aromatic carbocyclic ring(s) include phenyl, 1-naphthyl (bicyclic), 2-naphthyl (bicyclic), anthracenyl (tricyclic), phenanthrenyl (tricyclic), pentacenyl (pentacyclic), and like groups. Examples of polycyclic ring systems in which at least one aromatic carbocyclic ring is fused to one or more cycloalkyl and/or cycloheteroalkyl rings include, among others, benzo derivatives of cyclopentane (i.e., an indanyl group, which is a 5,6-bicyclic cycloalkyl/aromatic ring system), cyclohexane (i.e., a tetrahydronaphthyl group, which is a 6,6-bicyclic cycloalkyl/aromatic ring system), imidazoline (i.e., a benzimidazolinyl group, which is a 5,6-bicyclic cycloheteroalkyl/aromatic ring system), and pyran (i.e., a chromenyl group, which is a 6,6-bicyclic cycloheteroalkyl/aromatic ring system). Other examples of aryl groups include benzodioxanyl, benzodioxolyl, chromanyl, indolinyl groups, and the like. In certain embodiments, aryl groups can be optionally substituted. In certain embodiments, an aryl group can have one or more halogen substituents, and can be referred to as a “haloaryl” group. Perhaloaryl groups, i.e., aryl groups where all of the hydrogen atoms are replaced with halogen atoms (e.g., —C₆F₅), are included within the definition of “haloaryl.” In certain embodiments, an aryl group is substituted with another aryl group and can be referred to as a biaryl group. Each of the aryl groups in the biaryl group can be optionally substituted.

The term “cyclic olefin” as used herein refers to compounds comprising one, two, three or more non-aromatic rings (fused and/or unfused rings) that comprise at least one pair of adjacent carbon atoms in the ring which are bound to one another by an unsaturated bond. The ring may optionally be substituted or unsubstituted, and the cyclic olefin may optionally comprise one unsaturated bond (“monounsaturated”), two unsaturated bonds (“di-unsaturated”), three unsaturated bond (“tri-unsaturated”), or more than three unsaturated bonds. In certain embodiments, the cyclic olefin is optionally substituted.

The term “optionally substituted” refers to a chemical group, such as a cyclic olefin, wherein one or more hydrogen may be replaced with a substituent as described herein, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like.

The present disclosure provides a method for performing a metathesis reaction, the method comprising: providing a reaction solution comprising at least one olefin substrate and a metathesis catalyst; and exposing the reaction solution to ultrasound thereby inducing the metathesis reaction. The metathesis reaction can be a cross metathasis reaction, a ring closing metathesis reaction, a ring opening metathesis reaction, or a ring opening polymerization reaction.

In certain embodiments, the metathesis catalyst is not a tungsten, molybdenum, tantalum, ruthenium or rhenium oxyhalide, halide, oxide, or organic ammonium salt, a vinylidine, allenylidene or higher cumulenylidene complex comprising ruthenium osmium (p-cymene)RuCl(PCy₃)(═C═C═CPh₂)⁺, WCl₆/Me₄Sn, or

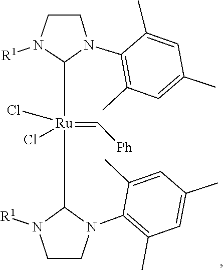

wherein R¹ is methoxy poly(butylene oxide)butyl.

In certain embodiments, the metathesis catalyst is not a vinylidine, allenylidene and higher cumulenylidene complex of the general formula:

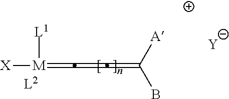

wherein M is Ru or Os;
X is an anionic ligand;
L² is selected from the group consisting of phosphine, sulfonated phosphine, fluorinated phosphine, functionalized phosphine bearing up to three aminoalkyl-, ammonium alkyl-, alkoxyalkyl-, alkoxycarbonylalkyl-, hydroxycarbonylalkyl-, hydroxyalkyl-, ketoalkyl-groups, phosphite, phosphinite, phosphonite, arsine, and stibene;
L¹ is a neutral π-bond ligand;
A and B are independently selected from hydrogen or from the group consisting of C₁-C₂₀ alkyl, aryl, C₂-C₂₀ alkenyl, alkynyl, C₁-C₂₀ alkoxy, carboxylate, carbamate, C₂-C₂₀ alkenyloxy, alkynyloxy, aryloxy, alkoxylcarbonyl, C₁-C₂₀ alkylthio, alkylsulfonyl, alkylsulfinyl, arylthiol, arylsulfonyl, arylsulfinyl, alkylamido, alkylamino, each of which is optionally substituted with C₁-C₁₀ alkyl, perfluoroalkyl, aryl, alkoxy or with halogen;
Y—is a non-coordinating anion; and
N is 0-5.

The metathesis catalyst is not particularly limited and the present disclosure contemplates the use of all known metathesis catlaysts. In certain embodiments, the metathesis catalysts is a ruthenium metathesis catalyst, a molybdenum metathesis catalyst, an osmium metathesis catalyst, or a tungsten metathesis catalyst.

Metathesis catalysts are disclosed in PCT/US95/09655, PCT/US96/12654, PCT/US02/12165, and U.S. Pat. No. 6,211,391 which are hereby incorporated by reference in their entirety.

In certain embodiments, the metathesis catalyst has Formula 1:

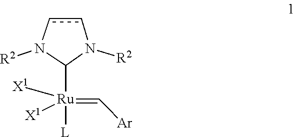

wherein L is PR³₃;
X¹ for each instance is independently an anionic ligand; Ar is phenyl optionally substituted with 1, 2, 3, 4 or 5 substituents selected from the group consisting of alkyl, cycloalkyl, aryl, aralkyl, heterocyloalkyl, heteroaryl, halide, nitro, cyano, ether, aldehyde, ketone, ester, carboxy, amine, amide, acyl amine, sulfone, and sulfonamide;
R² for each instance is independently alkyl, cycloalkyl, or aryl; and
R³ for each instance is independently alkyl, cycloalkyl, or aryl.

In certain embodiments, X¹ for each instance is independently chloride, bromide, C₁-C₆ carboxylate, C₁-C₆ alkoxide, benzoate, or C₁-C₆ alkylsulfonate.

In certain embodiments of the metathesis catalyst of Formula 1, X¹ is chloride, Ar is phenyl; R² is optionally substituted phenyl; and R³ is alkyl or cycloalkyl. In certain embodiments, X¹ is chloride, Ar is phenyl; R² is 2-methyl-phenyl, 2,4,6-trimethyl-phenyl, or 2,6-diisopropyl-phenyl; and R³ is isopropyl or cyclohexyl.

Exemplary metathesis catalysts include, but are not limited to CAS Number 250220-36-1 (Grubbs Catalyst® M101), CAS Number 172222-30-9 (Grubbs Catalyst® M102), CAS Number 340810-50-6 (Grubbs Catalyst® M200), CAS Number 1307233-23-3 (Grubbs Catalyst® M201), CAS Number 536724-67-1 (Grubbs Catalyst® M202), CAS Number 254972-49-1 (Grubbs Catalyst® M203), CAS Number 246047-72-3 (Grubbs Catalyst® M204), CAS Number 927429-60-5 (Grubbs Catalyst® M205), CAS Number 373640-75-6 (Grubbs Catalyst® M206), CAS Number 253688-91-4 (Grubbs Catalyst® M207), CAS Number 1190427-50-9 (Grubbs Catalyst® M208), CAS Number 1190427-49-6 (Grubbs Catalyst® M209), CAS Number 1255536-61-8 (Grubbs Catalyst® M220), CAS Number 1031262-76-6 (Grubbs Catalyst® M310), CAS Number 934538-12-2 (Grubbs Catalyst® M350), CAS Number 203714-71-0 (Hoveyda Grubbs Catalyst® M700), CAS Number 1025728-56-6 (Hoveyda Grubbs Catalyst® M710), CAS Number 1212008-99-5 (Hoveyda Grubbs Catalyst® M711), CAS Number 301224-40-8 (Hoveyda Grubbs Catalyst® M720), CAS Number 927429-61-6 (Hoveyda Grubbs Catalyst® M721), CAS Number 635679-24-2 (Hoveyda Grubbs Catalyst® M722), CAS Number 1025728-57-7 (Hoveyda Grubbs Catalyst® M730), CAS Number 1212009-05-6 (Hoveyda Grubbs Catalyst® M731), CAS Number 1383684-54-5 (Grubbs Catalyst® M800), CAS Number 1632041-02-1 (Hoveyda Grubbs Catalyst® M1001), and CAS Number 1352916-84-7 (Hoveyda Grubbs Catalyst® M2001).

In certain embodiments, the at least one olefin substrate is a cylic olefin, an acyclic olefin, or a mixture thereof. In certain embodiments, the at least one olefin substrate comprises one or more functional groups selected from the group consisting of alkyl, aralkyl, cycloalkyl, heterocycloalkyl, aryl, heteroaryl, a perhaloalkyl, a nitro, a nitrile, a halide (e.g., F, Cl, Br, or I), a hydroxyl, an ether, a thioether, a tertiary amine, an aldehyde, a ketone, an ester, an amide, a carbonate, a phosphite, phosphonate, a phosphate, a carbamate, a urea, and a sulfonamide.

In certain embodiments, the cyclic olefin comprises 3-24 carbon atoms. In certain embodiments, the cyclic olefin includes one or more heteroatoms (e.g., 1, 2, 3, 4, or 5) selected from the group consisting of O, N, S, and P, in the ring system. The cyclic olefin can be a strained cyclic olefin or an unstrained cyclic olefin.

In certain embodiments, the cyclic olefin has the Formula 2:

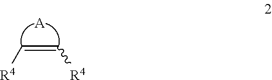

wherein each R⁴ for is independently selected from the group consisting of hydrogen, alkyl, cycloalkyl, alkenyl, alkynyl, aryl, heteroaryl, halo, ester, ketone, and amido; and A is a saturated or unsaturated optionally substituted hydrocarbon, wherein the hydrocarbon optionally comprises one or more heteroatoms selected from the group consisting of O, N, S, and P, between the carbon atoms thereof, and two or more substituents attached to the hydrocarbon are optionally linked to form a bicyclic olefin or polycyclic olefin.

Examples of cyclic olefins include, but are not limited to, cyclobutene, cyclopropene, cyclopentene, cyclohexene, cycloheptene, cyclooctene, cyclononene, cyclodecene, cycloundecene, cyclododecene, tricyclodecene, tetracyclodecene, octacyclodecene, and cycloeicosene, and substituted versions thereof such as methylcyclopentene (e.g., 1-methylcyclopentene, 4-methylcyclopentene), ethylcyclopentene (e.g., 1-ethylcyclopentene), isopropylcyclohexene (e.g., 1-isopropylcyclohexene), chlorocyclopentene (e.g., 1-chlorocyclopentene), fluorocyclopentene (e.g., 1-fluorocyclopentene), methoxycyclopentene (e.g., 4-methoxy-cyclopentene), ethoxycyclopentene (e.g., 4-ethoxycyclopentene), cyclopentene-thiol (e.g., cyclopent-3-ene-thiol), methylsulfanyl-cyclopentene (e.g., 4-methylsulfanyl-cyclopentene), methylcyclohexene (e.g., 3-methylcyclohexene), methylcyclooctene (e.g., 1-methylcyclooctene), dimethylcyclooctene (e.g., 1,5-dimethylcyclooctene), 1,3-cyclopentadiene, 1,3-cyclohexadiene, 1,4-cyclohexadiene, heptadiene (e.g., 1,3-cycloheptadiene), octadiene (e.g., 1,5-cyclooctadiene, 1,3-cyclooctadiene), norbornenes, such as bicyclo[2.2.1]hept-2-ene and substituted versions thereof, norbornadiene, (bicyclo[2.2.1]hepta-2,5-diene) and substituted versions thereof, and polycyclic norbornenes, and substituted versions thereof, bicyclic and polycyclic olefins, such as dicyclopentadiene (DCPD); trimer and higher order oligomers of cyclopentadiene (e.g., cyclopentadiene tetramer, cyclopentadiene pentamer); ethylidenenorbomene; dicyclohexadiene; norbornene; 5-methyl-2-norbornene; 5-ethyl-2-norbornene; 5-isobutyl-2-norbornene; 5,6-dimethyl-2-norbornene; 5-phenylnorbornene; 5-benzylnorbornene; 5-acetylnorbornene; 5-methoxycarbonylnorbornene; 5-ethyoxycarbonyl-1-norbornene; 5-methyl-5-methoxy-carbonylnorbornene; 5-cyanonorbornene; 5,5,6-trimethyl-2-norbornene; cyclo-hexenylnorbornene; endo,exo-5,6-dimethoxynorbornene; endo,endo-5,6-dimethoxynorbornene; endo,exo-5,6-dimethoxycarbonylnorbornene; endo,endo-5,6-dimethoxycarbonylnorbornene; 2,3-dimethoxynorbornene; norbornadiene; tricycloundecene; tetracyclododecene; 8-methyltetracyclododecene; 8-ethyltetracyclododecene; 8-methoxycarbonyltetracyclododecene; 8-methyl-8-tetracyclododecene; 8-cyanotetracyclododecene; pentacyclopentadecene; pentacyclohexadecene; and the like; and oxanorbornenes.

In instances in which the one or more olefin substrates comprise a cyclic olein, when the reaction solution is irradiated with ultrasound at one or more initiation locations of the reaction solution with ultrasound that is sufficient to trigger a FROMP, optionally discontinuing the ultrasound, allowing the FROMP to propagate originating from the one or more initiation locations through the reaction solution thereby forming the metathesis product.

Acyclic olefins useful in connection with the methods described herein are not particularly limited and can be acyclic olefin. In certain embodiments, the acyclic olefin is an acrylate, a methacrylate, an alkyl acrylate, an alkyl methacrylate, an alkene, a styrene, an alkadiene, a vinyl halide, a vinyl nitrile, a vinyl ester, or a vinyl amide. In instances in which the reaction solution further comprises an acyclic olefin, the acyclic olefin can be present at 0.5-60 wt %, 2.5-60 wt %, 5-60 wt %, 7.5-60 wt %, 10-60 wt %, 15-60 wt %, 20-60 wt %, 25-60 wt %, 30-60 wt %, 40-60 wt %, 50-60 wt %, 0.5-50 wt %, 0.5-40 wt %, 0.5-30 wt %, 0.5-25 wt %, 0.5-20 wt %, 0.5-15 wt %, 0.5-10 wt %, 0.5-7.5 wt %, 0.5-5 wt %, 0.5-2.5 wt %, 20-50 wt %, or 30-40 wt % relative to the total weight acyclic olefin and cyclic olefin.

In certain embodiments, the at least one olefin substrate comprises a cyclic olefin and optionally an acyclic olefin. In certain embodiments, the at least one olefin substrate comprises DCPD, 5-ethylidene-2-norbornene, or 1,5-cyclooctadiene and optionally acrylate, methacrylate, methacrylate, N-methylolacrylamide, or methyl methacrylate.

In certain embodiments, the reaction solution further comprises an inhibitor for extending the pot life of the metathesis reaction selected from P(OR⁵)₃, wherein R⁵ for each instance is independently C₁-C₁₂ alkylphosphite, C₁-C₉ alkylphosphite, C₁-C₆ alkylphosphite, C₃-C₆ alkylphosphite, triphenylphosphites, 4-dimethylamnopyridine (DMAP), triphenylphosphine, tricyclohexylphosphine, and limonene. Exemplary triakylphosphites include, but are not limited to, trimethylphosphite, triethylphosphite, tri-n-propylphosphite, tri-iso-propylphosphite tri-n-butylphosphite, tri-sec-butylphosphite, tri-iso-butylphosphite, tri-tert-butylphosphite, tripentylphosphite, and trihexylphosphite.

The inhibitor can be present in the reaction solution at 10-200 mol %, 50-200 mol %, 100-200 mol %, 150-200 mol %, 50-150 mol %, or 50-100 mol % relative to the metathesis catalyst.

The reaction solution can further comprise nanoparticles selected from the group consisting of metal oxide nanoparticles, carbon-based nanoparticles, and metallic foam nanoparticles. The metal oxide nanoparticles can be oxides of Group 3-15 of the Periodic Table. Exemplary metal oxide nanoparticles include, but are not limited to, oxides of titanium, zirconium, chromium, molybdenum, tungsten, manganese, iron, ruthenium, iridium, cobalt, rhodium, nickel, palladium platinum, copper, silver, gold, zinc, cadmium, aluminum, gallium, indium, thallium, silicon, germanium, tin, lead, and bismuth. The carbon-based nanoparticles can be graphite nanoparticles, graphene nanoparticles, graphene oxide nanoparticles, reduced graphene oxide nanoparticles, carbon nanotube nanoparticles, carbon black nanoparticles, carbon nanofiber nanoparticles, and combinations thereof. The metallic foam nanoparticles can comprise one or more of titanium, zirconium, chromium, molybdenum, tungsten, manganese, iron, ruthenium, iridium, cobalt, rhodium, nickel, palladium platinum, copper, silver, gold, zinc, cadmium, aluminum, gallium, indium, thallium, silicon, germanium, tin, lead, and bismuth. The metallic foam nanoparticles can have irregular pores or regular pores.

The reaction solution can comprise any inert solvent in which the metathesis catalyst and the least one olefin substrate are at least partially soluble. Suitable solvents include, but are not limited to aromatic solvents, aliphatic solvents, haloalkanes, esters, ethers, alcohols, water, and combinations thereof. Exemplary solvents useful in the methods described herein include toluene, xylenes, mesitylene, chlorobenzene, phenylcyclohexane, heptanes, hexanes, dichloromethane, dichloroethane, ethyl acetate, isopropyl acetate, tertbutylmethylether, 2-methyltetrahydrofuran, methanol, ethanol, butanol, tetrahydrofuran, diethyl ether, or mixtures thereof.

The metathesis catalyst can be present in the reaction solution at 0.001-10 mol %, 0.001-5 mol %, 0.001-4 mol %, 0.001-3 mol %, 0.001-2 mol %, 0.001-1 mol %, 0.01-1 mol %, 0.01-0.9 mol %, 0.01-0.8 mol %, 0.01-0.7 mol %, 0.01-0.6 mol %, 0.01-0.5 mol %, 0.01-0.4 mol %, 0.01-0.3 mol %, 0.01-0.2 mol %, or 0.01-0.1 mol % relative to the at least one olefin substrate.

Irradiating the reaction solution may initiate the metathesis reaction, accelerate propagation of the metathesis reaction, or a combination thereof.

Ultrasound can be applied to the reaction solution directly, e.g., by contacting the reaction solution directly with an ultrasound probe, or indirectly, e.g., by subjecting the reaction vessel (such as a mold) to ultrasound. The ultrasound may also be transmitted via a medium, such as a solvent (e.g., water or oil) or air.

The ultrasound can be at 10-100 kHz, 10-90 kHz, 10-80 kHz, 10-70 kHz, 10-60 kHz, 10-50 kHz, 10-40 kHz, 10-30 kHz, 10-20 kHz, 15-25 kHz, or 20-40 kHz. The ultrasound can have a power of 6.6-750 W, 10-750 W, 25-750 W, 50-750 W, 100-750 W, 100-700 W, 100-650 W, 100-600 W, 100-550 W, 100-500 W, 100-400 W, 100-300 W, 100-250 W, 150-250 W, 100-200 W, or 150-200 W.

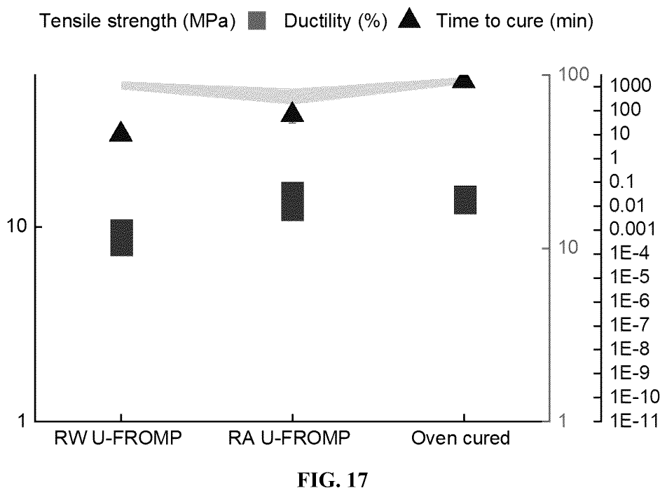

As demonstrated in FIG. 17, the duration of ultrasound irradiation can be used to increase the trans/cis ratio of olefins present in the metathesis product. Accordingly, the method described herein can yields a metathesis product with greater than 50%, greater 60%, greater than 70%, greater than 80%, or greater than 90% trans isomer. In certain embodiments, the method described herein yields a metathesis product with 50-90%, 60-90%, 70-90%, 80-90%, 50-80%, 50-70%, 50-60%, 60-80%, 60-70%, or 70-80% trans isomer. In certain embodiments, the method described herein provides a metathesis product with a higher ratio of trans isomer than the method conducted under thermal initiation conditions and in the absence of ultrasound irradiation.

Advantageously, the metathesis reaction can be initiated at reduced temperatures in certain embodiments, the metathesis reaction is irradiated with ultrasound at −50° C. to 50° C., −40° C. to 50° C., −30° C. to 50° C., −20° C. to 50° C., −20° C. to 40° C., −20° C. to 30° C., −20° C. to 20° C., −20° C. to 10° C., −20° C. to 0° C., −20° C. to −10° C., −20° C. to −15° C., −50° C. to −10° C., −40° C. to −10° C., or −30° C. to −10° C.

Provided herein is a method for conducting frontal polymerization in low-temperature environments, such as at −20° C. The method can involve placing the reaction solution in a fridge, freezing it, and then initiating ultrasound-induced FROMP by introducing ultrasound probes into the frozen reaction solution. The front starts and propagates at a low temperature of approximately 70-120° C. while maintaining an acceptable velocity. The resulting polymer exhibits enhanced mechanical properties, particularly ductility and toughness, surpassing those of oven-cured pDCPD. This method enables the fabrication of high-performance polymers in harsh environmental conditions, such as open areas with temperatures as low as −20° C., without the need for an expensive oven cure. The ability to cure a polymer at such temperatures may seem unusual, but our findings demonstrate the feasibility and advantages of this approach.

Also provided herein is a polymer prepared in accordance with the method described herein.

The polymer can be prepared from one or more of the at least one olefin substrates described herein. In certain embodiments, the polymer comprises polydicyclopentadiene, poly(dicyclopentadiene-co-methacrylate), poly(dicyclopentadiene-co-methyl methacrylate), poly(dicyclopentadiene-co-N-methylolacrylamide), polynorbornene, poly(norbornene-co-methacrylate), poly(norbornene-co-methyl methacrylate), poly(norbornene-co-N-methylolacrylamide), polytricyclopentadiene, poly(tricyclopentadiene-co-methacrylate), poly(tricyclopentadiene-co-methyl methacrylate), poly(tricyclopentadiene-co-N-methylolacrylamide), polycyclooctene, poly(cyclooctene-co-methacrylate), poly(cyclooctene-co-methyl methacrylate), poly(cyclooctene-co-N-methylolacrylamide), polycyclooctadiene, poly(cyclooctadiene-co-methacrylate), poly(cyclooctadiene-co-methyl methacrylate), poly(cyclooctadiene-co-N-methylolacrylamide), polycyclobutene, poly(cyclobutene-co-methacrylate), poly(cyclobutene-co-methyl methacrylate), poly(cyclobutene-co-N-methylolacrylamide), polycyclopropene, poly(cyclopropene-co-methacrylate), poly(cyclopropene-co-methyl methacrylate), poly(cyclopropene-co-N-methylolacrylamide), polyoxanorbornene, poly(oxanorbornene-co-methacrylate), poly(oxanorbornene-co-methyl methacrylate), or poly(oxanorbornene-co-N-methylolacrylamide).

In instances in which the polymer is prepared from a cyclic olefin and an acyclic olefin, the acyclic olefin can be present in the polymer at 0.5-60 wt %, 2.5-60 wt %, 5-60 wt %, 7.5-60 wt %, 10-60 wt %, 15-60 wt %, 20-60 wt %, 25-60 wt %, 30-60 wt %, 40-60 wt %, 50-60 wt %, 0.5-50 wt %, 0.5-40 wt %, 0.5-30 wt %, 0.5-25 wt %, 0.5-20 wt %, 0.5-15 wt %, 0.5-10 wt %, 0.5-7.5 wt %, 0.5-5 wt %, 0.5-2.5 wt %, 20-50 wt %, or 30-40 wt % relative to the total weight acyclic olefin and cyclic olefin in the polymer.

In certain embodiments, the polymer further comprises one or more types of nanoparticles selected from the group consisting of metal oxide nanoparticles and carbon-based nanoparticles. The metal oxide nanoparticles can be oxides of Group 3-15 of the Periodic Table. Exemplary metal oxide nanoparticles include, but are not limited to, oxides of titanium, zirconium, chromium, molybdenum, tungsten, manganese, iron, ruthenium, iridium, cobalt, rhodium, nickel, palladium platinum, copper, silver, gold, zinc, cadmium, aluminum, gallium, indium, thallium, silicon, germanium, tin, lead, and bismuth. The carbon-based nanoparticles can be graphite nanoparticles, graphene nanoparticles, graphene oxide nanoparticles, reduced graphene oxide nanoparticles, carbon nanotube nanoparticles, carbon black nanoparticles, carbon nanofiber nanoparticles, and combinations thereof. The metallic foam nanoparticles can comprise one or more of titanium, zirconium, chromium, molybdenum, tungsten, manganese, iron, ruthenium, iridium, cobalt, rhodium, nickel, palladium platinum, copper, silver, gold, zinc, cadmium, aluminum, gallium, indium, thallium, silicon, germanium, tin, lead, and bismuth. The metallic mesh can have irregular pores or regular pores.

The present disclosure also provides a composite comprising a polymer prepared in accordance with the method described herein and one or more nanoparticles and/or one or more fabrics. The nanoparticles can be selected from the group consisting of metal oxide nanoparticles, carbon-based nanoparticles, and metallic foam nanoparticles. The metal oxide nanoparticles can be oxides of Group 3-15 of the Periodic Table. Exemplary metal oxide nanoparticles include, but are not limited to, oxides of titanium, zirconium, chromium, molybdenum, tungsten, manganese, iron, ruthenium, iridium, cobalt, rhodium, nickel, palladium platinum, copper, silver, gold, zinc, cadmium, aluminum, gallium, indium, thallium, silicon, germanium, tin, lead, and bismuth. The carbon-based nanoparticles can be graphite nanoparticles, graphene nanoparticles, graphene oxide nanoparticles, reduced graphene oxide nanoparticles, carbon nanotube nanoparticles, carbon black nanoparticles, carbon nanofiber nanoparticles, and combinations thereof. The metallic foam nanoparticles can comprise one or more of titanium, zirconium, chromium, molybdenum, tungsten, manganese, iron, ruthenium, iridium, cobalt, rhodium, nickel, palladium platinum, copper, silver, gold, zinc, cadmium, aluminum, gallium, indium, thallium, silicon, germanium, tin, lead, and bismuth. The metallic foam nanoparticles can have irregular pores or regular pores.

The one or more fabrics can comprise a carbon fiber, a glass fiber, a carbon fiber bundle, a metal wire mesh, aramid fiber, au ultra-high molecular weight polyethylene, a ceramic fiber, a steel fiber, a copper fiber, or combinations thereof. The fabric can be woven (e.g., plain weave or twill weave), non-woven, or a combination thereof.

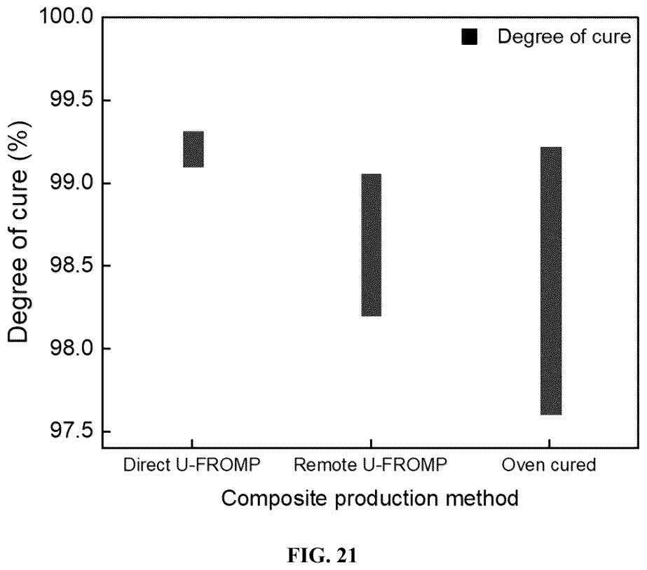

In certain embodiments, the composite comprises 1, 2, 3, 4, 5, 6, 7, 8, 9, 10, 11, 12, 13, 14, 15, 16, 17, 18, 19, 20, or more layers of fabric. Advantageously, the methods described herein can yield a higher degree of cure of composites comprising one or more layers of fabric than traditional curing methods (such as thermally initiated FROMP and oven curing) As demonstrated in FIG. 21, composite comprising

The composite can comprise up to 20%, up to 30%, up to 40%, up to 50%, up to 60%, or up to 70% by weight of the one or more nanoparticles and/or one or more fabrics. In certain embodiments, the composite comprises 1-70 wt %, 5-70 wt %, 10-70 wt %, 20-70 wt %, 30-70 wt %, 40-70 wt %, 50-70 wt %, 60-70 wt %, or 65-70 wt % relative to the total weight of the polymer and the one or more nanoparticles and/or one or more fabrics.

In certain embodiments, the method further comprises: stacking one or more layers of fabric, suffusing (e.g., spreading the reaction solution through and/or over the fabric such that the reaction solution substantially permeates the fabric) the fabric with the reaction solution thereby forming a suffused fabric, and irradiating the suffused fabric with ultrasound at one or more initiation locations that is sufficient to trigger a FROMP, optionally discontinuing the ultrasound, allowing the FROMP to propagate originating from the one or more initiation locations through the suffused fabric.

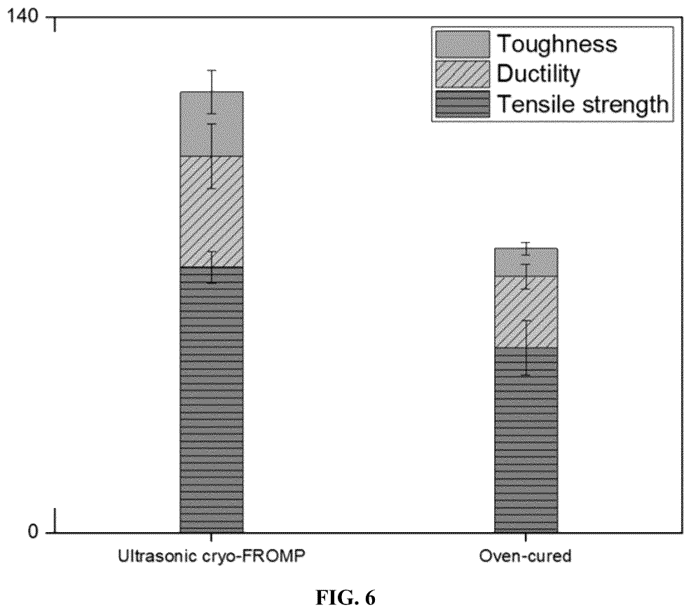

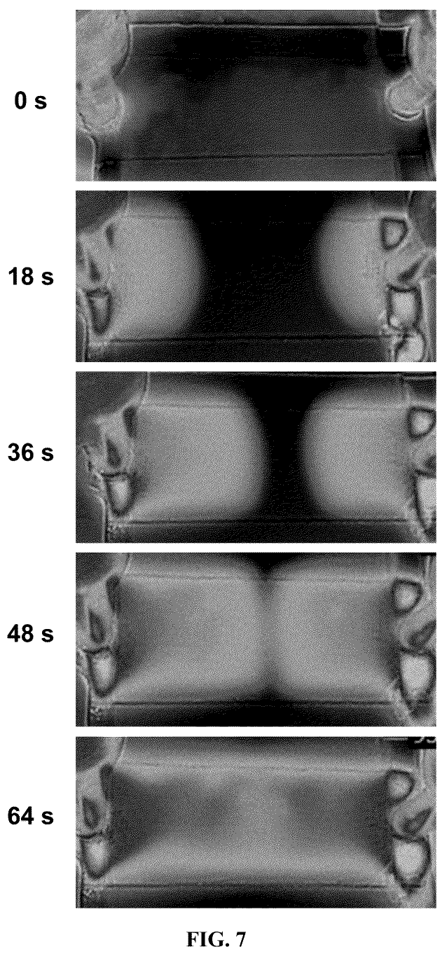

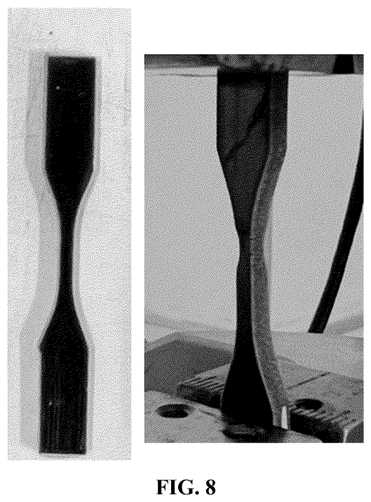

Polymers and composites prepared in accordance with the methods descirbed herein can exhibit enhanced mechanical properties, particularly in terms of ductility and toughness, surpassing those of oven-cured pDCPD. FIG. 6 highlights the superior mechanical properties of the final polymer compared to oven-cured samples. The method described in this patent offers significant advantages, especially in harsh environmental conditions. By enabling polymer curing at −20° C., it opens up possibilities for fabricating high-performance polymers in open areas where temperatures can drop as low as −20° C. This eliminates the need for expensive oven curing equipment and provides a cost-effective solution for in situ polymer fabrication.

Polymers and composites prepared in accordance with the methods described herein can advantageously exhibit improved physical properites relative to polymers prepared using thermal curing (i.e., using identical conditions using thermal initiation or oven curing for the polymerization in the absence of ultrasound). In certain embodiments, the coposite is a carbon fiber-reinforced plastic (CFRP) comprising a polymer prepared in accordance with the method described herein and woven carbon fiber. In certain embodiments, the composite CFRP prepared in accordance with the methods described herein have improved tensile strength, tensile modulus, flexural strength, and flexural modulus. The CFRPs prepared in accordance with the methods described herein can have a tensile strength of 430-500 MPa, 440-500 MPa, 450-500 MPa, 460-500 MPa, 470-500 MPa, 480-500 MPa, 490-500 MPa, 495-500 MPa, 496-500 MPa, 497-500 MPa, 498-500 MPa, or 499-500 MPa. The polymers prepared in accordance with the methods described herein can have a tensile modulus of 42-70 GPa, 42-60 GPa, 42-50 GPa, 43-50 GPa, 44-50 GPa, 45-50 GPa, 46-50 GPa, 47-50 GPa, 48-50 GPa, 49-50 Gpa, 50-70 GPa, 55-70 GPa, 60-70 GPa, 65-70 GPa, 66-70 GPa, 67-70 GPa, 68-70 GPa, or 69-70 GPa. The polymers prepared in accordance with the methods described herein can have a flexural strength of 250-300 MPa, 260-300 MPa, 270-300 MPa, 280-300 MPa, 290-300 MPa, 295-300 MPa, 296-300 MPa, 297-300 MPa, 298-300 MPa, or 299-300 MPa. The polymers prepared in accordance with the methods described herein can have a flexural modulus of 30-40 GPa, 31-40 GPa, 32-40 GPa, 33-40 GPa, 34-40 GPa, 35-40 GPa, 36-40 GPa, 37-40 GPa, 38-40 GPa, or 39-40 GPa.

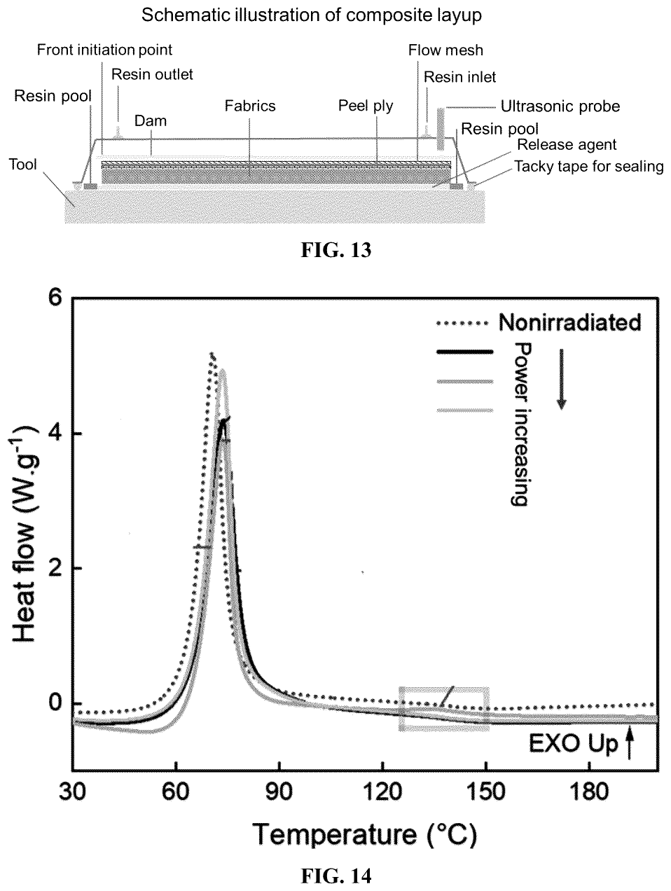

The present disclosure also provides a device for performing the metathesis reaction described herein. Referring to FIG. 13, the device (100) for performing the metathesis reaction comprises: a mold (101) for receiving the reaction solution (107), a first ultrasound probe (102) and a slide (103) disposed on the mold (101), wherein the mold body defines a first opening (106) for receiving the first ultrasound probe (102). In certain embodiments, the device further comprises sealing tape (105).

The mold (101) can be made of or lined with a mold release material for facilitating removal of the polymer product from the mold. In certain embodiments, the mold (101) comprises a perfluoroalkoxy alkane (PFA), a perfluoropolyether, or a perfluoroalkane, such as PTFE.

In certain embodiments, the device further comprises one or more additional ultrasound probes and the mold body defines one or more additional openings for receiving the one or more additional ultrasound probes. In certain embodiments, the device further comprises a second ultrasound probe and the mold body defines a second opening for receiving the second ultrasound probe. In certain embodiments, the device comprises 1, 2, 3, 4, or more ultrasound probes.

The slide (103) can be made of any material. In certain embodiments, the slide (103) is made of a transparent material, such as glass.

The size of the first ultrasound probe (102) is not particularly limited and any ultrasound probe may be used in connection with the device described herein. In certain embodiments, the first ultrasound probe (102) can range in size from 1.6 mm to 26 mm.

The first (106) opening and any additional openings on the mold can be of any shape. In certain embodiments, the opening is polygonal or may be a shape having a curvature such as a circle or an ellipsoid.

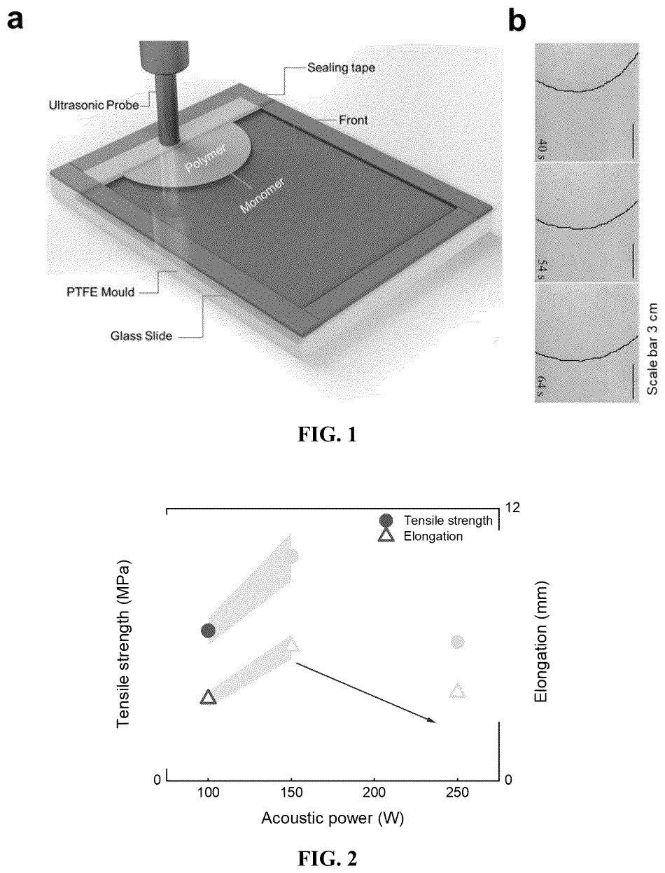

The present disclosure provides a polymerization device for controlling FROMP using ultrasound waves. FIG. 1 illustrates the components of the device, including a mold (e.g., made of or coated with PTFE) with a slide (e.g., made of glass) that features an opening for inserting the ultrasound probe. The reaction solution can be injected through a tube or directly poured into the mold.

The polymerization process consists of two main steps. In step I, the ultrasound machine is turned on to initiate the front through acoustic cavitation. The front initiation time is crucial for controlling the polymerization process. In step II, the front propagates while the ultrasound probe is turned off. The position of the probe and the ultrasound amplitude are key factors influencing the final polymer structure and uniformity. The front temperature and velocity can be measured using embedded thermocouples and a graded glass, enabling precise monitoring of the polymerization process.

A key advantage of this design is the ability to control the front temperature and velocity by adjusting the ultrasound amplitude. This control directly influences the polymer structure and mechanical properties, as illustrated in FIG. 2. The ultrasound-induced FROMP method allows for a wide range of tensile strength and ductility without the need for changing the reaction solution chemistry or adding new monomers or nanoparticles. By harnessing the power of ultrasound mechanical waves, the latent potentials of the reaction solution system can be fully utilized.

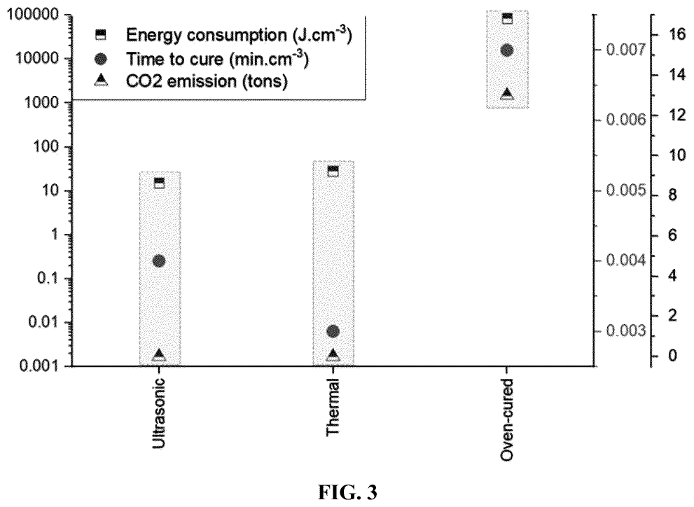

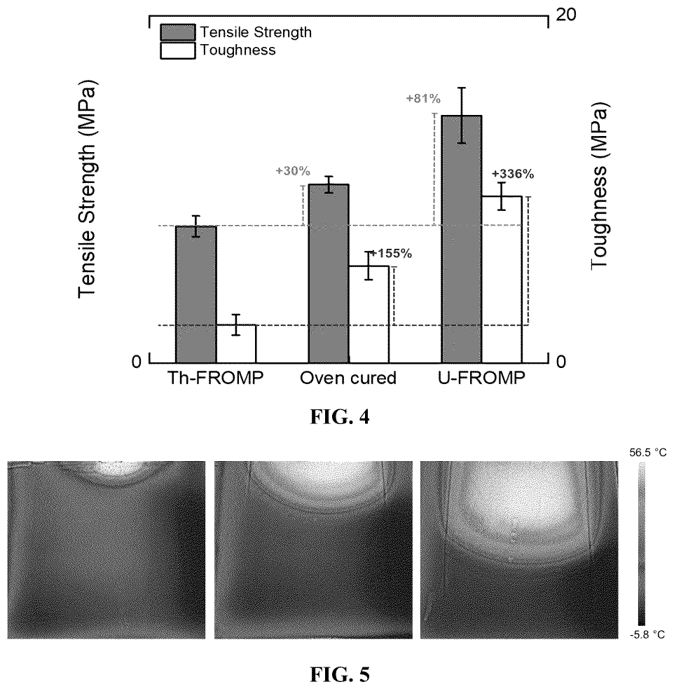

The proposed ultrasound-induced FROMP method offers several advantages over thermal FROMP. Optimized ultrasound parameters result in the production of polymers with superior mechanical properties compared to conventional oven-cured pDCPD, which typically requires around 27 hours for curing at high temperatures (FIG. 3). This method is not only rapid and energy-efficient but also surpasses the mechanical properties of conventional oven-cured samples (FIG. 4).

Ultrasonic cryo-FROMP method operates at reduced temperatures, achieving a front temperature of approximately 70-120° C. This decrease in temperature significantly minimizes the temperature spike that occurs when two fronts merge, in contrast to thermal fronts that typically reach temperatures of 176° C. The frozen reaction solution between the merging fronts serves as a heat sink, further lowering the front temperature. Consequently, the produced polymer exhibits a uniform structure, surpassing the quality of oven-cured samples. The ultrasonic cryo-FROMP technique facilitates the fabrication of extensive polymer slabs with multiple ignition points, addressing previous system limitations. The current invention presents an ultrasonic cryo-FROMP system, offering an innovative method for conducting frontal polymerization at lower temperatures. This system achieves a front temperature of around 70-120° C., significantly reducing the temperature spike during the merging of two fronts compared to conventional thermal fronts, which reach temperatures of 176° C.

In the ultrasonic cryo-FROMP system, the frozen reaction solution between two merging fronts acts as a heat sink, effectively decreasing the front temperature. This temperature reduction offers several benefits. Firstly, the lower temperature rise during front merging ensures that it remains below the degradation temperature of the polymer, preventing any adverse effects on the final polymer structure. Secondly, the resulting polymer exhibits a uniform structure, surpassing the quality of oven-cured samples. Measurements and observations indicate that the ultrasonic cryo-FROMP system provides superior results compared to traditional methods. FIG. 7 illustrates the temperature drop to around 70-120° C. in the system, emphasizing the reduced temperature spike during front merging. This temperature reduction is attributed to the frozen reaction solution acting as a heat sink. FIG. 6 demonstrates the mechanical properties of the final polymer, surpassing the quality of oven-cured samples. The advantages of the ultrasonic cryo-FROMP method extend beyond temperature control and improved polymer structure. This method enables the fabrication of large polymer slabs with multiple ignition points, addressing previous system limitations. The ability to create large-scale polymer structures without compromising quality and uniformity opens new possibilities for various applications.

In certain embodiments, the method described herein utilizes nanoparticles, such as carbon nanotubes (CNTs) to enhance heat conductivity. Due to their exceptional thermal properties, CNTs enable the initiation of FROMP in under 10 seconds. The rapid initiation of the polymerization process ensures that nanoparticles are uniformly dispersed before any deposition or agglomeration can occur. An added advantage of this method is the reduced energy consumption compared to pure pDCPD polymers. The energy required for fabricating nanocomposites using this accelerated curing process is approximately one-third of that needed for pure pDCPD polymers. This energy efficiency makes the method not only time-saving but also cost-effective. After fabrication, samples were cut for further mechanical property analysis (FIG. 8). Applications of this method include the production of high-performance nanocomposites with enhanced mechanical, thermal, and electrical properties. The homogeneous distribution of nanoparticles achieved through rapid curing improves the overall performance and functionality of the resulting materials. These nanocomposites find applications in various industries, including aerospace, automotive, electronics, and construction.

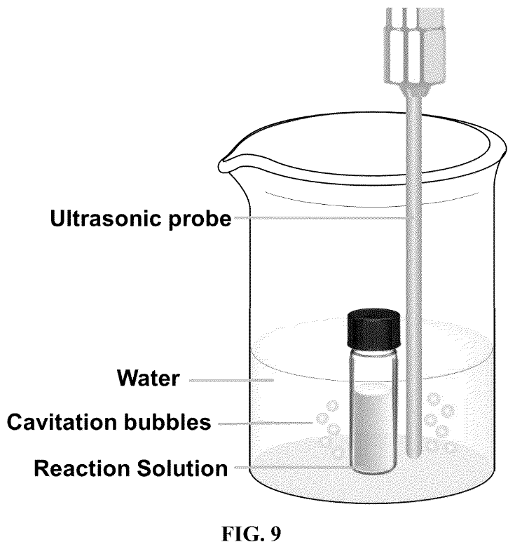

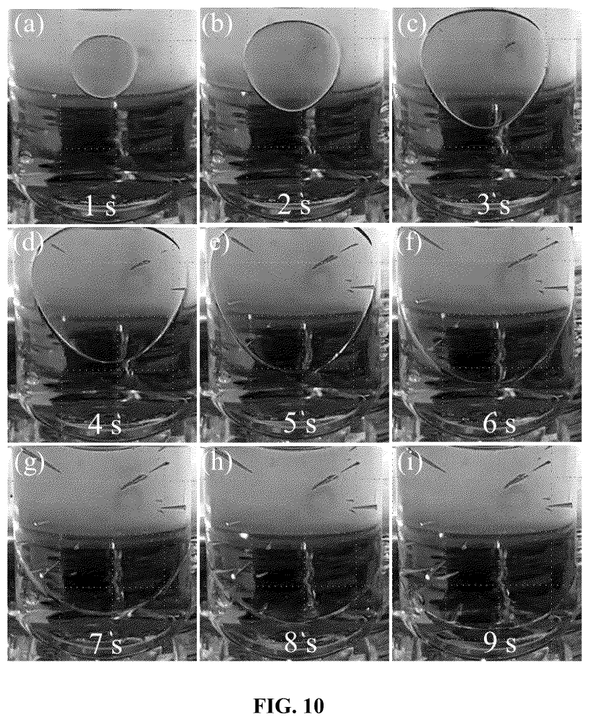

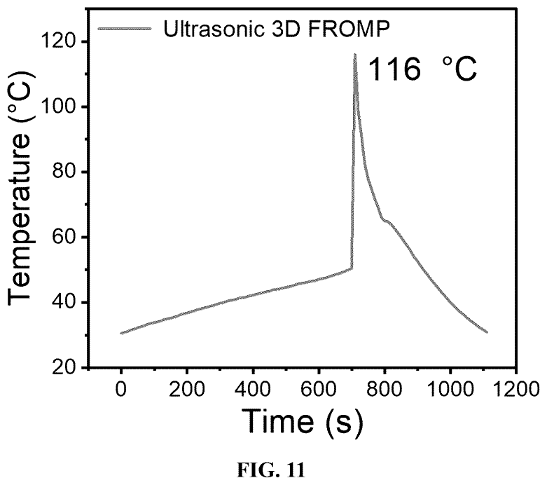

The current invention introduces a novel method for initiating a three-dimensional (3D) front in FROMP using remote ultrasonic excitation, as illustrated in FIG. 9. Traditional FROMP methods require the probe to be inside the reaction solution. However, we also present a remote ultrasonic FROMP method, where the front can be initiated even when the probe is not in direct contact with the reaction solution. In the remote ultrasonic FROMP method, a three-dimensional front starts from the center of the reaction solution and propagates until complete polymerization occurs. This 3D front differs from the vertical 2D thermal FROMP, as the curing time is approximately half that of the latter for the same volume of reaction solution (FIG. 10). The initiation time for remote ultrasonic FROMP is extended compared to traditional FROMP methods. This is due to the creation of cavitation bubbles in the water surrounding the reaction solution, rather than within the reaction solution itself. As a result, a longer time is required to initiate the front. The initiation time ranges from 30 seconds to 11 minutes, depending on the specific conditions. Measurements indicate that the front temperature for remote ultrasonic FROMP reaches 116° C. (FIG. 11). However, it should be noted that no theoretical analysis currently exists to explain this observation. A hypothesis is put forward, suggesting that the lower heat loss in the center of the reactor allows the central part to reach the critical point necessary for breaking the activation energy barrier and initiating the front.

### EXAMPLES

### Materials

The following chemicals were used in this invention: Bicyclic olefins such as dicyclopentadiene (DCPD), 5-ethylidene-2-norbornene (ENB), and monocyclic olefin: 1,5-cyclooctadiene (COD). Other chemicals include methyl methacrylate (MMA), N-methylolacrylamide (NMA), and phenyl cyclohexane, (1,3-bis(2,4,6-trimethylphenyl)-2-imidazolidinylidene)dichloro(phenylmethylene)(tricyclohexylphosphine)ruthenium, benzylidene[1,3-bis(2,4,6-trimethylphenyl)-2-imidazolidinylidene]dichloro(tricyclohexylphosphine)ruthenium, dichloro[1,3-bis(2,4,6-trimethylphenyl)-2-imidazolidinylidene](benzylidene) (tricyclohexylphosphine)ruthenium(II) second-generation Grubbs' Catalyst® (G2), and tributyl phosphite (TBP) inhibitor.

### Ultrasound-Induced Frontal Ring-Opening Metathesis Polymerization (U-FROMP) Process for the Development of Polymers

For each experiment, an adequate amount of G2 was weighed and dissolved in phenyl cyclohexane (1-4 mL). Next, TBP (20-140 μL) was added to the solution. The catalyst/inhibitor solution was then added to DCPD/ENB solution (9,000-10,000 molar equivalents relative to G2) or COD (10,000 molar equivalents relative to G2), and the mixture was thoroughly mixed via magnetic stirrer. It is important to note that the reaction solution was used immediately after mixing to create liquid FROMP. Then, the direct or remote protocols were used to initiate polymerization.

### Direct U-FROMP

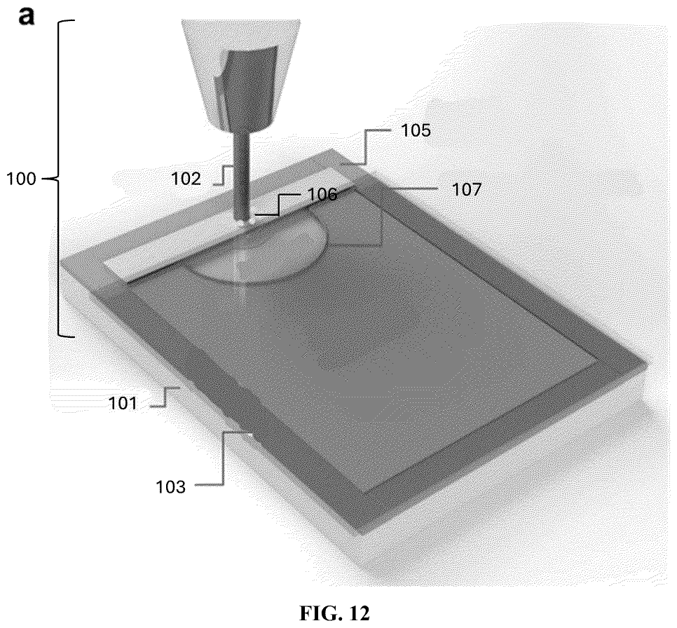

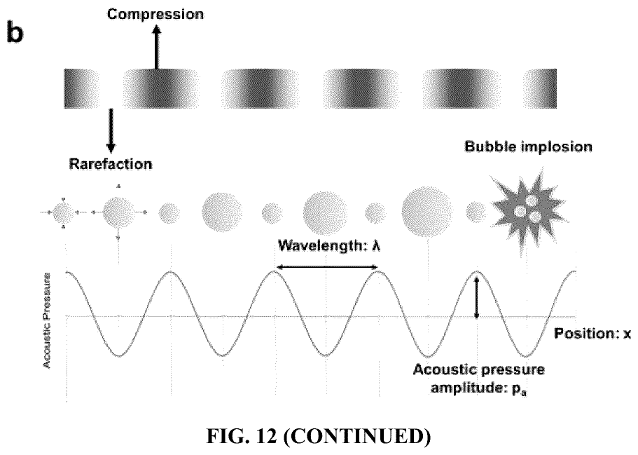

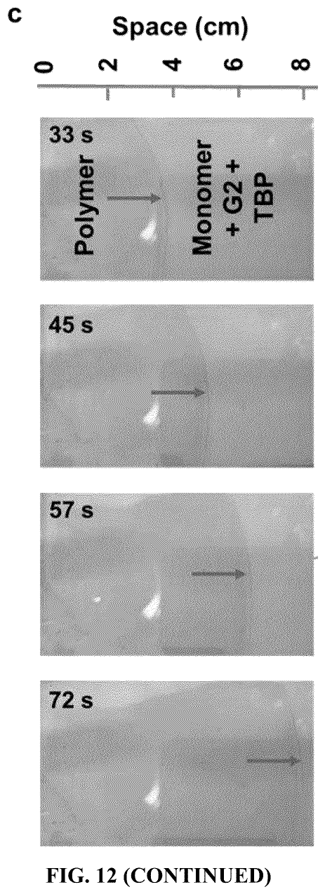

A 13 mm diameter probe connected to a sonicator (500-750 W, 20 kHz) was used at various amplitudes from 100-500 W. The probe was placed on the left side of the plane reactor with 2-5 mm immersion in the reaction solution (See FIG. 12a). For multi-points initiation two or more ultrasonic probes were used to initiate U-FROMP.

### Remote U-FROMP

For remote water initiation, reactors containing reaction solution were transferred to an ultrasonic bath with 40-45 kHz frequency at power 6.6-120 W. The time of initiation for remote U-FROMP depends on the height of the water inside the ultrasonic bath tank and also the water temperature. We changed the water temperature from 20° C. to 60° C. and the water height from 2.5 cm to 7.5 cm. We observed the dependence of initiation time, frontal characteristics, and polymer properties on the temperature and height of water. For remote air, the ultrasonic probe was placed on the top of glass part of the reactor with 1 mm distance. The power changed between 100 W to 500 W with 20 kHz frequency.

For both direct and remote U-FROMP, to effectively monitor the front temperature during FP, a T-type thermocouple was located inside the reaction solution before initiating the U-FROMP. The peak temperature during this process was measured using a thermocouple. Front propagation was then observed using a camera and a FUR E8xt thermal infrared camera. To identify the change of position of the front, we utilized the recorded films. The front velocity was calculated by the optimal trendline correlating the position of the front with respect to the time.

### Fabrication of Carbon Fiber Reinforced Plastics via U-FROMP

The novel composite system was inspired by a cost-effective vacuum-assisted resin infusion (VARI) while the novel design let us cure 12-layers carbon fiber fabrics with high fabric percentage (60-70 wt %) via frontal polymerization with near-zero energy consumption (6-10 J cm⁻³). The kit for the VARI process consists of an PTFE mold, vacuum pump, pressure pot, inlet, and outlet hoses for infusion of resin, peel plies, mesh flow, acrylic plate on top, acrylic spacers, spiral tube, and vacuum bagging as schematically presented in FIG. 13. After the layers of reinforcements are placed on the PTFE mold and covered by a vacuum bag, the resin inlet is locked by clamps, and the resin outlet was connected to the pressure pot of the vacuum pump. Then, the assembly was placed under maximum vacuum pressure (0.1 mbar) using the vacuum pump to remove the air trapped among the layers of the laminate. Then, the reaction solution was infused into the prepared layup. After the injection completion, the inlet hose was clamped, and the composite was cured based on direct or remote U-FROMP. This VARI design has two specifications compared to previous proposed VARI systems: (a) Using an acrylic plate on the top and (b) resin pool to start acoustic cavitation from resin pool and then propagating into the VARI layup until completion of curing. For direct U-FROMP, there is a hole to immerse the ultrasound probe inside the resin pool to initiate acoustic cavitation. For remote U-FROMP, after injection, the layup is transferred to an ultrasonic bath and U-FROMP activated remotely.

### Remote U-FROMP for Development of Copolymers

For copolymers, G2 dissolved in phenyl cyclohexane. Next, TBP (20-140 μL) was added to the solution. The catalyst/inhibitor solution was then added to DCPD/ENB solution (10,000 molar equivalents relative to G2). Methyl methacrylate was mixed with benzoyl peroxide (BPO) as thermal initiator. After adding the appropriate amount of DCPD and MMA reaction solutions, the solutions were cured via remote U-FROMP. The amount of MMA varied between 0.5-60 wt % relative to the total weight of DCPD and MMA. For all these compositions complete cure happened via frontal polymerization. For these experiments, reactors were transferred to ultrasonic bath with 40-45 kHz frequency and 6-120 W power.

### Cryo-FROMP for Development of High-Performance Polymers

For each experiment, G2 was weighed and dissolved in phenyl cyclohexane. Next, TBP (20-140 μL) was added to the solution. The catalyst/inhibitor solution was then added to DCPD/ENB solution (9,000-10,000 molar equivalents relative to G2) or COD (10,000 molar equivalents relative to G2), and the mixture was thoroughly mixed via magnetic stirrer. Then the reaction solution was injected into the reactor and transferred to freezer with −20° C. temperature. After 15-30 minutes dependent on the geometry of reactor, reaction solution temperature decreases down to −20° C. to −10° C. temperatures. Then a horn probe connected to a sonicator (500-750 W, 20 kHz) was used. The probe was placed on the left side of the plane reactor with 2-5 mm immersion in the frozen reaction solution and acoustic cavitation led to initiation of frontal propagation until complete cure of samples. For multi-points initiation two or more ultrasonic probes were used to initiate U-FROMP. Other sources of energies to cure polymers via Cryo-FROMP such as using heat or UV irradiation were used as comparative examples.

### Product Properties

### Polyolefins Developed Via Direct U-FROMP

To initiate acoustic cavitation for polymer synthesis, a power ultrasound horn is immersed in a liquid reaction solution containing monomer, catalyst, and inhibitor (FIG. 12a). We activated the ultrasound probe, until acoustic cavitation occurred in a specimen with varied dimensions and geometries. This initiated a radial front propagation of 1 cm. The probe was then turned off, and the reaction continued to propagate to completion without further sonication. Activation of the ultrasonication generates acoustic waves with alternating compression and rarefaction phases (FIG. 12b). During rarefaction, negative pressure induces the expansion of liquid elements, leading to the nucleation of dissolved gases and the formation of cavitation nuclei as tiny gas bubbles near the horn tip (FIG. 12a). These nuclei facilitate acoustic cavitation, as bubbles undergo violent collapse during the compression phase, emitting shock waves into the liquid. This collapse generates high pressures and intense localized heating, as explained by the hotspot theory, effectively initiating the polymerization front (as depicted in FIG. 12c). Acoustic cavitation presents a distinct mechanism from thermal boiling, as it is driven by negative pressure rather than thermal energy, resulting in the violent collapse of bubbles that produce unique effects not observed in traditional boiling processes. This phenomenon is pivotal in influencing the properties of polymers subjected to ultrasound treatment, as evidenced by previous studies. Due to the relatively small and circular probe diameter in comparison to the mold width, the initiation type was characterized as point-like, resulting in a rapidly propagating front with a concave shape (FIG. 12c).

### Mechanism of U-FROMP

From a mechanistic point of view, U-FROMP demonstrates the swift and controlled DCPD polymerization using a second-generation Grubbs catalyst due to high ring strain energy (RSE) stored in norbornene part of DCPD. DCPD ring strain energy is 90 k mol⁻¹ and for 1,5-cyclooctadiene (COD) is 56 kJ mol⁻¹. Due to the high ring strain stored in the norbornene part of DCPD, the polymerization is highly exothermic as depicted in FIG. 14 and depending on the ultrasound power the polymerization enthalpy is on the order of 240-400 J g⁻¹.

Varying the ultrasound power from 100 W to 500 W alters the acoustic cavitation, bubble dynamics, and frontal characteristics thereby impacting polymer properties. For an acoustic power of 100 W, the polymer properties closely resemble those achieved through thermal initiation. At lower acoustic intensities, cavitation is controlled, leading to uniform polymerization and properties similar to thermal initiation. As power increases to 150 W, enhanced tensile strength and ductility are observed. Beyond the 200 W threshold, excessive cavitation leads to non-uniform bubble collapse, embedding bubbles within the polymer matrix and degradation of mechanical properties. This weakening could be due to mechanisms such as microvoid formation or polymer degradation, which are typical at high cavitation intensities.

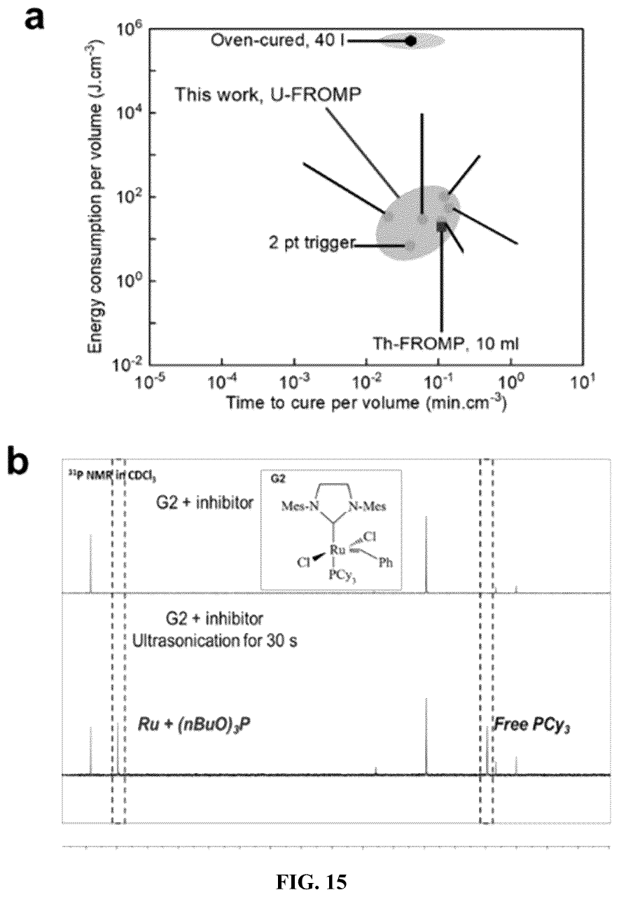

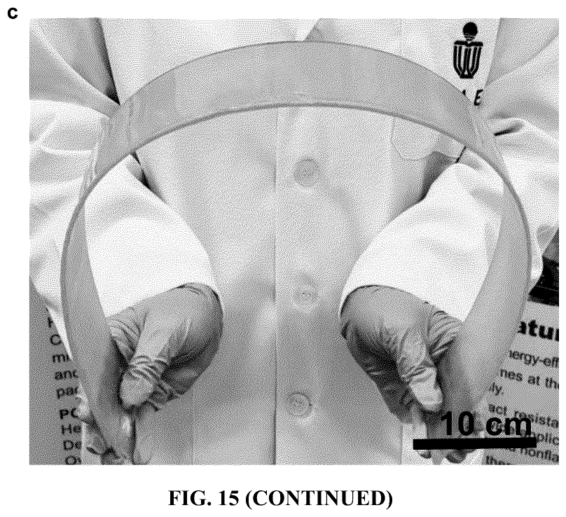

The initiation time is directly correlated with energy consumption. Energy consumption and fabrication efficiency are crucial requisites in FP curing strategies, particularly within the context of green manufacturing initiatives aiming to reduce CO₂ emissions. As the Th-FROMP has proved to be an energy-efficient curing strategy, here we discuss the energy consumption of U-FROMP as a new FROMP method which shows energy savings compared to conventional oven curing (FIG. 15a). In comparison to the oven curing strategy using recommended curing cycles, with around 5×10⁵ J cm⁻³ in energy consumption for 0.5-40 L resin (which is the maximum capacity of our curing oven), the implementation of U-FROMP significantly decreased consumed energy by several orders of magnitude (FIG. 15a). According to the information provided by The Hong Kong Electric Company in 2021, the CO₂ emissions of electricity usage is 0.71 kg CO₂ per kWh. Therefore, for the conventional oven curing strategy, approximately 13 tons of CO₂ will be produced, while for our U-FROMP, this value can be significantly reduced to 1-5×10⁻⁵ tons. Moreover, unlike Th-FROMP, where increasing the amount of resin results in a linear decrease in energy consumption per cm³, U-FROMP exhibits an increase in energy consumption as the resin volume increases. Consequently, when the resin volume is increased from 10 mL to 200 mL in U-FROMP, the energy consumption per unit volume remains approximately constant. This behavior is attributed to U-FROMP's dependence on volume, whereas Th-FROMP is influenced primarily by the initiation point and not by the resin quantity.

After optimization of acoustic power, we focus more on the frontal characteristics and structural changes during U-FROMP. In optimized U-FROMP, the average frontal velocity is very close to Th-FROMP. However, the frontal temperature of U-FROMP was much lower than the front temperature of Th-FROMP. Moreover, the exothermic heat of reaction decreased. The significant difference in exothermic heat of reaction and frontal temperature highlighted an obvious change in thermal behavior during the curing process in U-FROMP.

To confirm the observed frontal polymerization initiated by ROMP without other polymerization or dimerization, sole DCPD was sonicated under the same condition, showing no obvious change under our sonication condition (FIG. 15b) and short time ultrasonication without heat would not change the monomer composition. Moreover, a series of NMR tests were conducted to show that our FROMP can be initiated via necessary ultrasonication process without obvious thermal behaviour. Free PCy₃ species (10 ppm) and new ruthenium phosphite species (130 ppm) could be observed in 31P NMR after ultrasonication of a mixture of Grubbs catalyst and phosphite inhibitor for various times in FIG. 15b, showing ligands exchange in this sonication process with negligible temperature change. In this exchange process, the dissociation of phosphine ligand can lead to the formation of 14 e⁻ Ru species followed by recombination for ruthenium phosphite species. During this process, the 14 e⁻ ruthenium intermediate was the active center in common ROMP, and this observed ligand exchange further explain how ultrasonication can initiate the FROMP. The observation of a lower front temperature while maintaining similar front velocity suggests enhanced catalytic efficiency due to accelerated initiation of G2 catalyst as observed in 31P NMR tests that would permit lower reaction temperatures and improve efficiency (FIG. 15b). These species improve the catalyst's activity, allowing polymerization to proceed effectively at reduced temperatures. Additionally, the reaction dynamics are likely optimized, resulting in minimized heat release as observed in dynamic DSC (FIG. 15), while still achieving rapid propagation.

U-FROMP samples demonstrated an average tensile strength of 50-80 MPa and ductility of 10-15%. In comparison to Th-FROMP, the yield strength and ductility increased. The simultaneous enhancement of tensile strength and ductility leads to a 100-350% increase in the toughness of the polymer. The obtained polymer via U-FROMP also is approximately 255% tougher than the reported value of neat epoxy resin (2.7 MPa). Based on the tensile and compression properties, it appears that the p-DCPD's plastic deformation behavior and fracture resistance altered by the applied ultrasound field. The decreased frontal temperature via U-FROMP process suggests that this method holds great promise in the usage of a multi-ignition strategy, facilitating efficient fabrication with greater elevated scalability as shown in FIG. 4c. The main drawback of the multi-ignition strategy is the sudden temperature spike and subsequent polymer degradation when two high-temperature fronts meet, resulting in a junction as a weak point during service. In terms of mechanical properties for the obtained samples, a significant increase in elongation at break of U-FROMP sample was observed, which means that the two merging fronts with lower frontal temperatures lead to more even boundary and lower polymer degradation due to temperature spike.

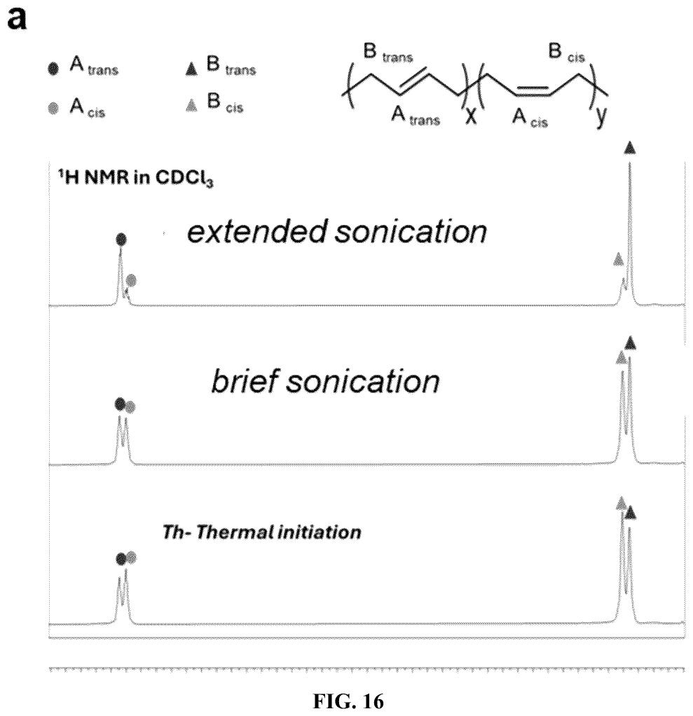

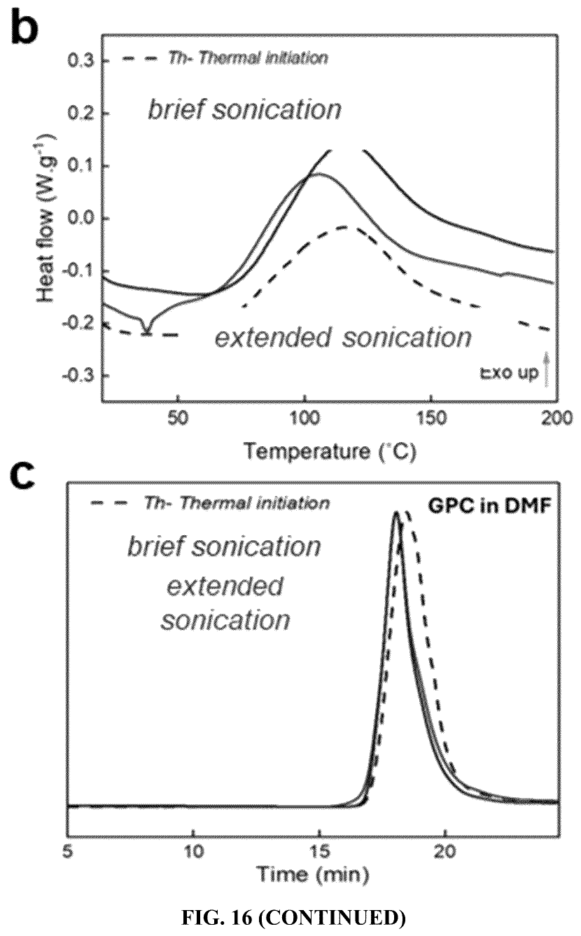

The FROMP of COD was initiated using either ultrasonication or heat, with reaction solutions incorporating G2 catalysts and TBP inhibitor. The reaction mixtures, contained in vials, were activated by an ultrasound probe and a soldering iron. After FROMP curing, the samples underwent various characterizations, including NMR, GPC, and DSC. For H NMR tests, samples were collected at an adequate distance from the initiation point where we make sure the front is propagating steadily and it is adequately far from initiation point, with the trans content qualitatively analyzed in the 5.3-5.5 ppm range (FIG. 16a). Interestingly, ultrasonication was found to increase the trans content, with longer sonication times leading to trans-abundant p-COD that was much harder than thermally initiated counterparts (FIG. 16a) and exhibited endothermic behavior as observed in DSC traces (FIG. 16b). This structural change and increased polymer crystallinity can be attributed to the differences between thermal and ultrasonication initiation. Mechanical waves during sonication influence the entire mixture more effectively than heat alone, promoting more ordered structures during the FROMP process. In addition to affecting the trans/cis ratio, ultrasonication initiation also resulted in higher molecular weights compared to the thermal method (FIG. 16c). The lower heat generated in U-FROMP and cavitation induced polymerization may reduce chain transfer behavior during polymerization as observed in solidification microstructure of other materials, resulting in relatively longer polymer chains.

### Polyolefins Developed Via Remote U-FROMP (Water or Air)

The use of water as a medium in the RW U-FROMP method enhances the thermal management of the reaction, providing a more uniform temperature distribution and accelerating the curing process. Similarly, the RA U-FROMP method, though slightly less efficient than RW U-FROMP, still offers substantial time savings, making both approaches highly attractive for industrial applications where time efficiency is critical. The remote U-FROMP method, utilizing either water or air as the medium (results shown in FIG. 17), demonstrates a remarkable reduction in curing time compared to traditional oven curing. The data indicate a staggering increase in production efficiency. This significant decrease in curing time is attributed to the rapid propagation of the polymerization front, facilitated by the ultrasonic energy, which effectively initiates and sustains the reaction with minimal energy input.

Despite the drastic reduction in curing time, the mechanical performance of p-DCPD polyolefins cured via remote U-FROMP remains comparable to that of oven-cured samples. The tensile properties, which include tensile strength and elongation at break, are crucial for evaluating the material's ability to withstand forces and deformation. The comparable tensile performance achieved through remote U-FROMP indicates that the rapid curing process does not compromise the integrity or strength of the polyolefins. This is likely due to the effective polymerization and cross-linking facilitated by the ultrasonic energy, which ensures a consistent and robust polymer network.

### CFRPs Developed Via U-FROMP

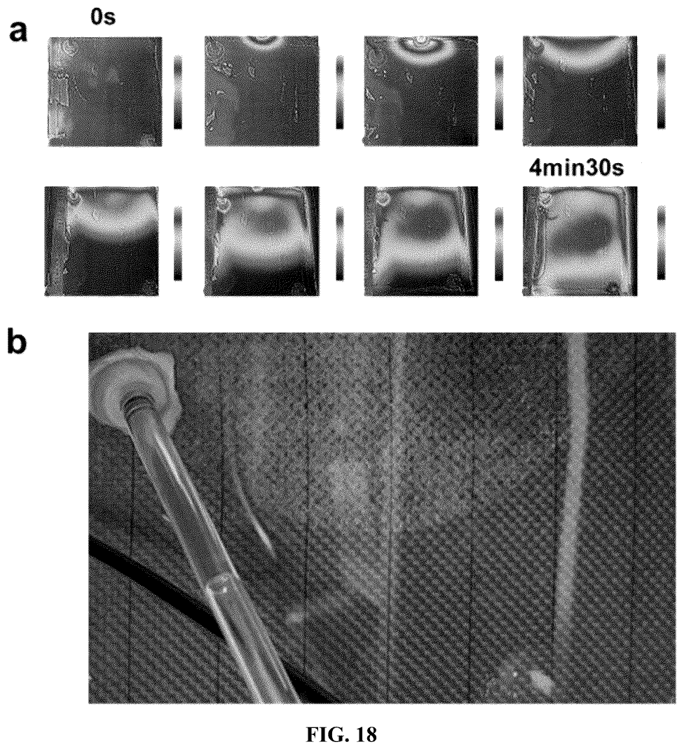

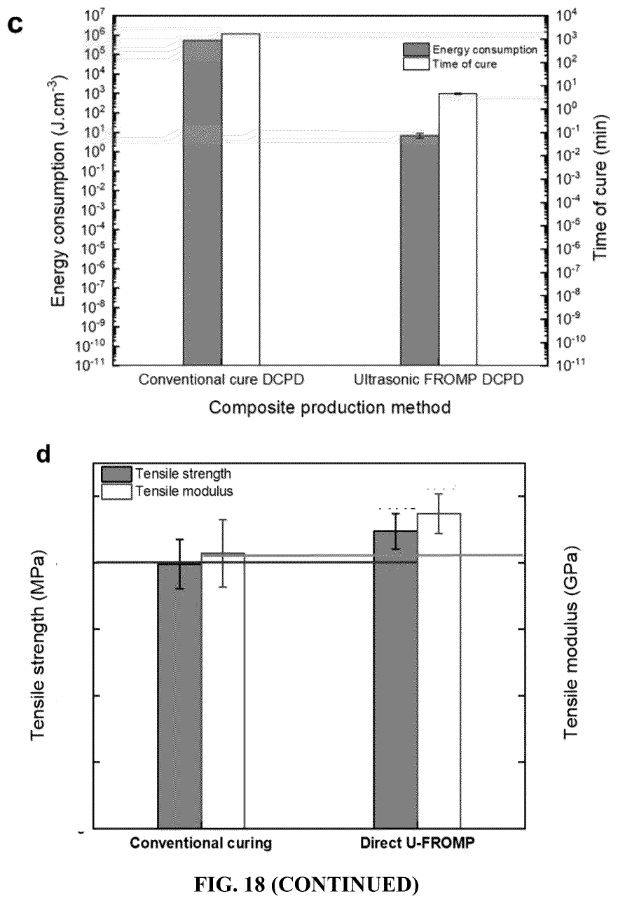

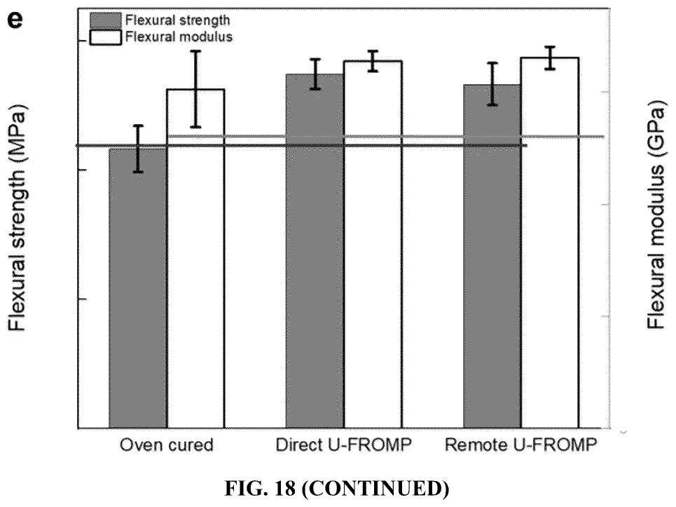

The development and optimization of composite materials are crucial for advancing technologies that demand high-performance materials with reduced environmental impact. FIG. 18 illustrates the significant advancements in energy efficiency and mechanical properties of carbon fiber reinforced polymers (CFRPs) when fabricated using the U-FROMP method. FIG. 18a presents an infrared (IR) camera capture during the reaction wave propagation, highlighting the thermal profile associated with the U-FROMP process. The image demonstrates the localized heating effect, which is a characteristic advantage of this method, allowing for targeted energy application and minimizing unnecessary heat dispersion. In FIG. 18b, a real-time photograph captures the frontal propagation of the polymerization reaction. This visual evidence underscores the efficiency of the U-FROMP method in terms of time and energy utilization, as the reaction progresses rapidly and uniformly through the material. The comparative analysis in FIG. 18c quantifies the energy consumption and time to cure for CFRPs produced via direct U-FROMP versus conventional curing methods. The data reveal a substantial reduction in both energy consumption and production time, underscoring the method's potential for sustainable manufacturing. The direct U-FROMP process achieves these savings by eliminating the need for prolonged oven curing, which is traditionally energy-intensive. FIG. 21 illustrates the degree of cure (%) of CFRPs comprising 12 layers of carbon fiber prepared using U-FROMP, Remote U-FROMP, and oven cured. The U-FROMP CFRP exhibited a degree of cure of 0.986-0.992, which is a very high degree of cure.

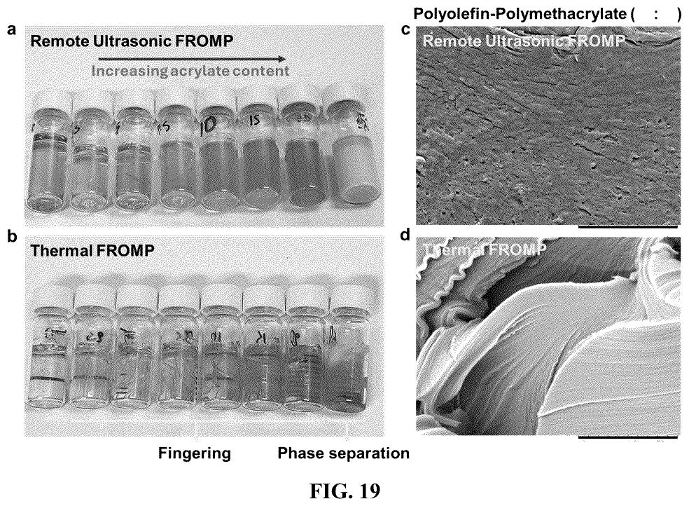

FIGS. 19d and 19e provide insights into the mechanical performance of CFRPs fabricated using the U-FROMP method compared to those cured in conventional ovens. The tensile and flexural properties are critical indicators of material performance, especially in applications requiring high strength and durability. The tensile strength for U-FROMP samples is in the range of 430-500 MPa, and the tensile modulus is 42-70 GPa. Tensile properties depicted in FIG. 18d show improvement over conventional oven-cured CFRPs. This enhancement is attributed to the homogeneous polymer matrix and optimal fiber-matrix adhesion achieved through the U-FROMP process, which facilitates superior load transfer and mechanical stability. Similarly, FIG. 18e illustrates the flexural properties of the CFRPs, further substantiating the mechanical advantages of the U-FROMP method. The flexural strength for U-FROMP composites is in the range of 250-300 MPa and the flexural modulus is in the range of 30-40 GPa. The improved flexural strength and modulus indicate the material's enhanced resistance to bending forces, making it suitable for structural applications where rigidity and resilience are paramount.

### Copolymers Developed Via Remote U-FROMP

The development of copolymers with tailored properties is crucial for advancing materials science, especially in applications that require specific mechanical and thermal characteristics. Remote U-FROMP offers a novel approach for fabricating copolymers, providing distinct advantages over conventional thermal methods. Photographic evidence reveals that copolymers with varying methacrylate content, fabricated via remote U-FROMP, exhibit notably uniform structures (FIG. 19a). In contrast, those developed through thermal FROMP display significant fingering (FIG. 19b), where distinct phases form due to uneven polymerization kinetics. This disparity becomes particularly pronounced with adding more than 40-60% methyl methacrylate (MMA), where Thermal FROMP samples exhibit substantial phase separation without successful frontal propagation because of methacrylate boiling (FIG. 19b). Scanning electron microscopy (SEM) micrographs further illustrate these structural differences, showing that copolymers synthesized via U-FROMP (FIG. 19c) have a more even and consistent microstructure, indicative of a well-integrated polymer network as compared with the thermal FROMP products (FIG. 19d). This uniformity is likely a result of the rapid and localized polymerization front facilitated by ultrasonic energy, which promotes consistent cross-linking and minimizes phase separation. Conversely, Thermal FROMP samples display pronounced structural irregularities, with visible phase boundaries and less cohesive polymer domains due to low boiling temperature of MMA that cause boiling rather than FP during heating process (FIG. 19d). These findings underscore the advantages of remote U-FROMP in producing copolymers with superior structural uniformity, particularly when incorporating significant amounts of methacrylate that cannot be yielded via thermal FROMP. Achieving a homogeneous copolymer structure without phase separation is critical for ensuring consistent material properties and performance.

### Polyolefins Developed Via Cryo-FROMP

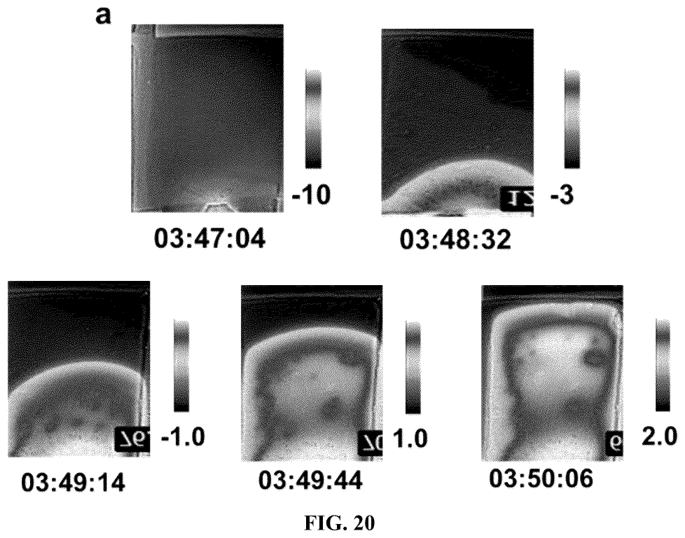

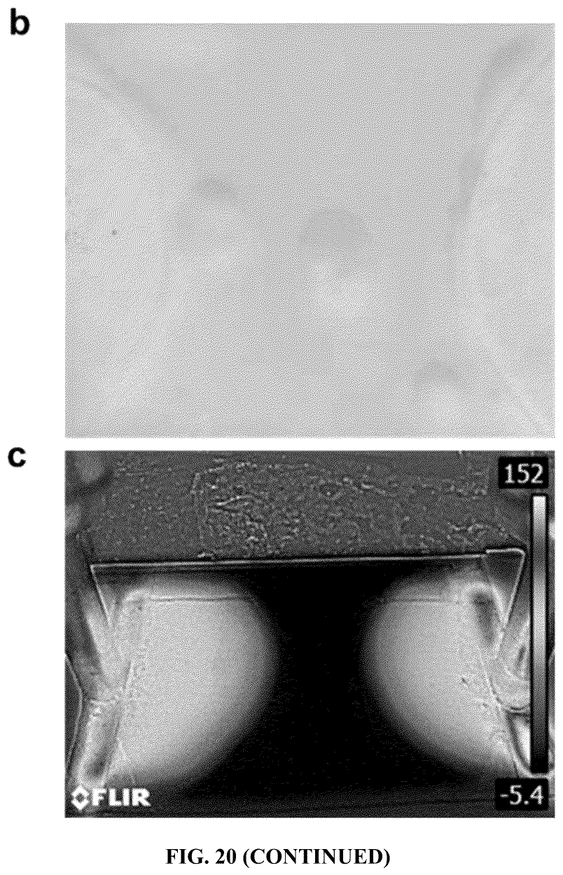

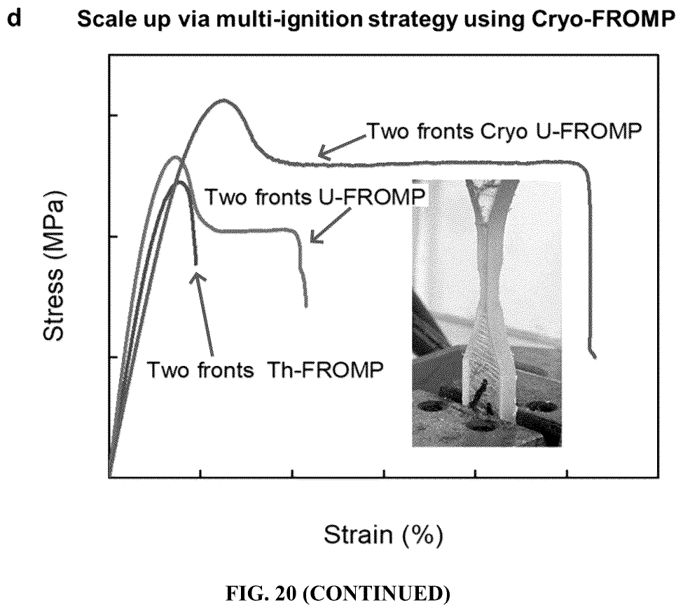

The development of polyolefins via Cryogenic Frontal Ring-Opening Metathesis Polymerization (Cryo-FROMP) represents a significant advancement in polymer synthesis, particularly in enhancing material properties and scalability. The process involves initiating polymerization at cryogenic temperatures (−20 to −15° C.) using ultrasonic energy, as illustrated by IR captures of the reaction wave propagation. These IR images, depicted in FIG. 20a, highlight the controlled and efficient progression of the polymerization front under low-temperature conditions, which is crucial for maintaining the integrity and uniformity of the resulting polymer structure. FIG. 20b demonstrates the innovative approach of two-point initiation in Cryo-FROMP, where polymerization is simultaneously triggered at two distinct locations, promoting more uniform wave propagation and enhancing the overall process efficiency. The IR camera capture in FIG. 20c provides further evidence of the reaction dynamics, showing how the polymerization fronts converge without causing detrimental temperature spikes. This convergence is particularly beneficial as it prevents the formation of weak points or defects at the junctions where the fronts meet, which is a common issue in conventional frontal polymerization techniques. As shown in FIG. 20d, this method significantly improves the ductility of the polyolefins, a critical mechanical property that denotes the material's ability to deform under stress without breaking. The enhanced ductility achieved through two-point initiation in Cryo-FROMP paves the way for better scalability of the process, making it more viable for industrial applications. This is because the absence of inferior parts due to temperature spikes ensures that the material maintains consistent quality and performance across larger scales. In summary, Cryo-FROMP, particularly with the two-point initiation strategy, offers a promising pathway for producing high-quality polyolefins with superior mechanical properties and scalability, addressing key challenges in polymer manufacturing and expanding the potential applications of these versatile materials.

What is claimed is:

1. A method for performing a metathesis reaction, the method comprising: providing a reaction solution comprising at least one olefin substrate and a metathesis catalyst; and
exposing the reaction solution to ultrasound thereby inducing the metathesis reaction, with the proviso that the metatesis catalyst is not a tungsten, molybdenum, tantalum, ruthenium or rhenium oxyhalide, halide, oxide, or organic ammonium salt, a vinylidine, allenylidene or higher cumulenylidene complex comprising ruthenium or osmium, (p-cymene)RuCl(PCy₃)(═C═C═CPh₂)⁺, WCl₆/Me₄Sn, or 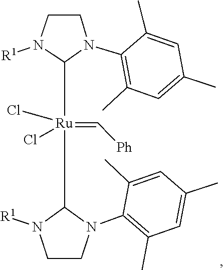
wherein R¹ is methoxy poly(butylene oxide)butyl.

2. The method of claim 1, wherein the metathesis catalyst is a ruthenium metathesis catalyst, a molybdenum metathesis catalyst, an osmium metathesis catalyst, or a tungsten metathesis catalyst.

3. The method of claim 1, wherein the metathesis catalyst has Formula 1: 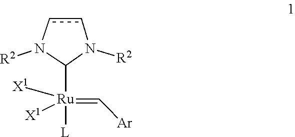
wherein L is PR³₃;
X¹ for each instance is independently an anionic ligand;
Ar is an optionally substituted phenyl;
R² for each instance is independently alkyl, cycloalkyl, or aryl; and
R³ for each instance is independently alkyl, cycloalkyl, or aryl.

4. The method of claim 1, wherein the metathesis catalyst has a CAS Number selected from the group consisting of: CAS Number 172222-30-9, CAS Number 250220-36-1, Number 340810-50-6, CAS Number 1307233-23-3, CAS Number 536724-67-1, CAS Number 254972-49-1, CAS Number 246047-72-3, CAS Number 927429-60-5, CAS Number 373640-75-6, CAS Number 253688-91-4, CAS Number 1190427-50-9, CAS Number 1190427-49-6, CAS Number 1255536-61-8, CAS Number 1031262-76-6, CAS Number 934538-12-2, CAS Number 203714-71-0, CAS Number 1025728-56-6, CAS Number 1212008-99-5, CAS Number 301224-40-8, CAS Number 927429-61-6, CAS Number 635679-24-2, CAS Number 1025728-57-7, CAS Number 1212009-05-6, CAS Number 1383684-54-5, CAS Number 1632041-02-1, and CAS Number 1352916-84-7.

5. The method of claim 1, wherein the metathesis catalyst has CAS Number 246047-72-3.

6. The method of claim 1, wherein the at least one olefin substrate comprises a cyclic olefin.

7. The method of claim 1, wherein the at least one olefin substrate comprises a cyclic olefin selected from the group consisting of norbornene, dicyclopentadiene, tricyclopentadiene, cyclooctene, cyclooctadiene, cyclobutene, cyclopropene, and an oxanorbornene.

8. The method of claim 1, wherien the metathesis reaction is conducted at −20° C. to −10° C.

9. The method of claim 1, wherein the ultrasound has a frequency of 20-100 kHz.

10. The method of claim 1, wherein the reaction solution further comprises P(OR⁵)₃, wherein R⁵ for each instance is independently C₁-C₁₂ alkyl.

11. The method of claim 1, wherein the reaction solution further comprises nanoparticles selected from the group consisting of metal oxides nanoparticles and carbon-based nanoparticles.

12. A method for performing a ring-opening metathesis polymeriztion reaction, the method comprising: providing a reaction solution comprising at least one olefin substrate, tributylphosphite, and a metathesis catalyst; and
exposing the reaction solution to ultrasound thereby inducing the ring-opening metathesis polymeriztion reaction, wherein the metathesis catalyst has CAS Number 246047-72-3, the at least one olefin substrate comprises comprises a cyclic olefin selected from the group consisting of norbornene, dicyclopentadiene, tricyclopentadiene, cyclooctene, cyclooctadiene, cyclobutene, cyclopropene, and an oxanorbornene, and optionally methyl methacrylate, N-methylolacrylamide, or methacrylate, and the ultrasound has a frequency of 20-100 kHz.

13. The method of claim 11, wherein the at least one olefin substrate comprises dicyclopentadiene.

14. A polymer prepared according to the method of claim 11.

15. The polymer of claim 13, wherein the polymer further comprises metal oxide nanoparticles or carbon-based nanoparticles.

16. The polymer of claim 13, wherein the polymer comprises polydicyclopentadiene, poly(dicyclopentadiene-co-methacrylate), or poly(dicyclopentadiene-co-methyl methacrylate).

17. The polymer of claim 15 further comprising carbon nanotubes.

18. A device for performing the metathesis reaction of claim 1, the device comprising:
a mold body for receiving the reaction solution;
a first ultrasound probe; and
a slide disposed on the mold body to form a reaction surface for the reaction solution to conduct the metathesis reaction, wherein the mold body defines a first opening for receiving the first ultrasound probe.

19. The device of claim 17 further comprising a second ultrasound probe and the mold body defines a second opening for receiving the second ultrasound probe, wherein the first ultrasound probe and the second ultrasound probe aer disposed at opposite ends of the mold body.

20. The device of claim 17, wherein the mold body comprises polytetrafluoroethylene.

21. The device of claim 17 further comprising one or more thermocouples for measuring the the temperature of the reaction solution.
